(19) United States
(12) Patent Application Publication
(10) Pub. No.: US 2025/0341900 A1
(43) Pub. Date: Nov. 6, 2025

(54) CRITERIA-BASED OPPORTUNISTIC MANIPULATION OF DISPLAYED CONTENT

(71) Applicant: Apple Inc., Cupertino, CA (US)

(72) Inventors: Luis R. DELIZ CENTENO, Fremont, CA (US); Rahul NAIR, Hayward, CA (US); Devin W. CHALMERS, Oakland, CA (US)

(21) Appl. No.: 19/185,742

(22) Filed: Apr. 22, 2025

Related U.S. Application Data
(60) Provisional application No. 63/642,597, filed on May 3, 2024.

(51) Int. Cl. G06F 3/0346; G06F 3/01; G06T 3/40; G06T 19/00

(52) U.S. Cl. CPC G06F 3/0346; G06F 3/012; G06T 3/40; G06T 19/006; G06F 3/013; G06T 2200/24

(57) ABSTRACT

Some examples of the disclosure are directed to systems and methods for displaying and updating the display of content such as a representation of a content item in a three-dimensional environment presented at an electronic device in response to movements of the electronic device and satisfying a set of criteria. Examples of the disclosure are directed to improving the user experience by automatically updating the representation of the content item when certain conditions are satisfied, such as when the orientation of the electronic device relative to the three-dimensional environment is appropriate (e.g., the criteria for updating the representation of the content item is satisfied).

### CROSS-REFERENCE TO RELATED APPLICATIONS

This application claims the benefit of U.S. Provisional Application No. 63/642,597, filed May 3, 2024, the content of which is incorporated herein by reference in its entirety for all purposes.

### FIELD OF THE DISCLOSURE

This relates generally to systems and methods of displaying and manipulating content such as representations of content items or user interface elements based on the satisfaction of associated criteria.

### BACKGROUND OF THE DISCLOSURE

Some computer graphical environments provide two-dimensional and/or three-dimensional environments where at least some objects displayed for a user's viewing are virtual and generated by a computer. In some examples, a physical environment (e.g., including one or more physical objects) is presented, optionally along with one or more virtual objects, in a three-dimensional environment. Some computer graphical environments provide two-dimensional and/or three-dimensional environments (e.g., extended reality environments) where at least some objects displayed for a user's viewing are virtual and generated by a computer. In some examples, the objects (e.g., including virtual user interfaces, such as a virtual navigation user interface) that are displayed in the three-dimensional environments are configured to be interactive (e.g., via direct or indirect inputs provided by the user). In some examples, an object (e.g., including a virtual user interface) is displayed with a respective visual appearance (e.g., a degree of detail of the virtual user interface, a number of user interface objects included in the virtual user interface, a size of the virtual user interface, etc.) in the three-dimensional environment. In some examples, the object is configured to move within the three-dimensional environment based on a movement of the viewpoint of the user (e.g., movement of the user's head and/or torso). In some examples, an undesired or unintended view (e.g., including an undesired or unintended visual appearance) of the object is presented to the user in the three-dimensional environment after movement of the viewpoint of the user.

### SUMMARY OF THE DISCLOSURE

Some examples of the disclosure are directed to systems and methods for displaying and updating the display of content such as a representation of a content item in a computer-generated environment. In some examples, the electronic device captures, via one or more cameras, a portion of one or more physical environments (e.g., indoor and/or outdoor environments) in the field of view of the one or more cameras of the electronic device, and presents, via the one or more displays, representations of the one or more physical objects and a content item within the one or more physical environments. In some examples, the electronic device detects movements of the electronic device, and in response, in accordance with a determination that one or more criteria are satisfied, updates the representation of the content item. In some examples, updating the representation of the content item can include scaling the size of the representation of the content item or clipping or cropping the content item based on the satisfaction of the one or more criteria. In some examples, updates to the representation of the content item can be sequentially continuous or discrete, and limited to a range of movement threshold relative to a predefined frame of reference.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrates block diagrams of an example architecture for an electronic device according to some examples of the disclosure.

FIG. 3A illustrates an electronic device that is displaying a representation of a content item, but has not yet made any movements (e.g., and/or detected any movements), and has not satisfied any criterion associated with updating the representation of the content item according to some examples of the disclosure.

FIG. 3B illustrates an electronic device that with roll direction movement in the physical environment (relative to the example of FIG. 3A) before one or more criteria associated with updating the representation of the content item are satisfied according to some examples of the disclosure.

FIG. 3B-1 illustrates an electronic device like the example of FIG. 3B but that includes a visual cue according to some examples of the disclosure.

FIG. 3B-2 illustrates an electronic device like the example of FIG. 3B but that includes a visual cue located in a predefined region of the content item according to some examples of the disclosure.

FIGS. 3C-3E illustrate an electronic device with roll direction movement in the physical environment satisfying the one or more criteria associated with updating the representation of the content item according to some examples of the disclosure.

FIG. 3F illustrates an electronic device with roll direction movement in the physical environment (relative to the example of FIG. 3A) that no longer satisfies the one or more criteria associated with updating the representation of the content item according to some examples of the disclosure.

FIGS. 3G-3I illustrate an electronic device with pitch direction movement in in the physical environment according to some examples of the disclosure.

FIGS. 3I-3K illustrate an electronic device with yaw direction movement in the physical environment according to some examples of the disclosure.

FIGS. 4A-4B illustrate an electronic device displaying a representation of a content item without a predetermined visual cue in the corner or border regions, and/or without a playback feature according to some examples of the disclosure.

FIGS. 5A-5C illustrate an electronic device that has sequentially moved about the yaw direction in the physical environment according to some examples of the disclosure.

FIG. 6 is a flow diagram illustrating an example process for displaying content and automatically updating content such as a representation of a content item based on detecting movements of the electronic device and in accordance with satisfying one or more criteria according to some examples of the disclosure.

### DETAILED DESCRIPTION

Some examples of the disclosure are directed to systems and methods for displaying and updating the display of content such as representation of a content item in a computer-generated environment. In some examples, the electronic device captures, via one or more cameras, a portion of one or more physical environments (e.g., indoor and/or outdoor environments) in the field of view of the one or more cameras of the electronic device, and presents, via the one or more displays, representations of the one or more physical objects and a content item within the one or more physical environments. In some examples, the electronic device presents, via one or more transparent or translucent displays, a content item overlaid on a view of the one or more physical environments. In some examples, the electronic device detects movements of the electronic device, and in response, in accordance with a determination that one or more criteria are satisfied, updates the representation of the content item. In some examples, updating the representation of the content item can include scaling the size of the representation of the content item or clipping or cropping the content item based on the satisfaction of the one or more criteria. In some examples, updates to the representation of the content item can be sequentially continuous or discrete, and limited to a range of movement threshold relative to a predefined frame of reference.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

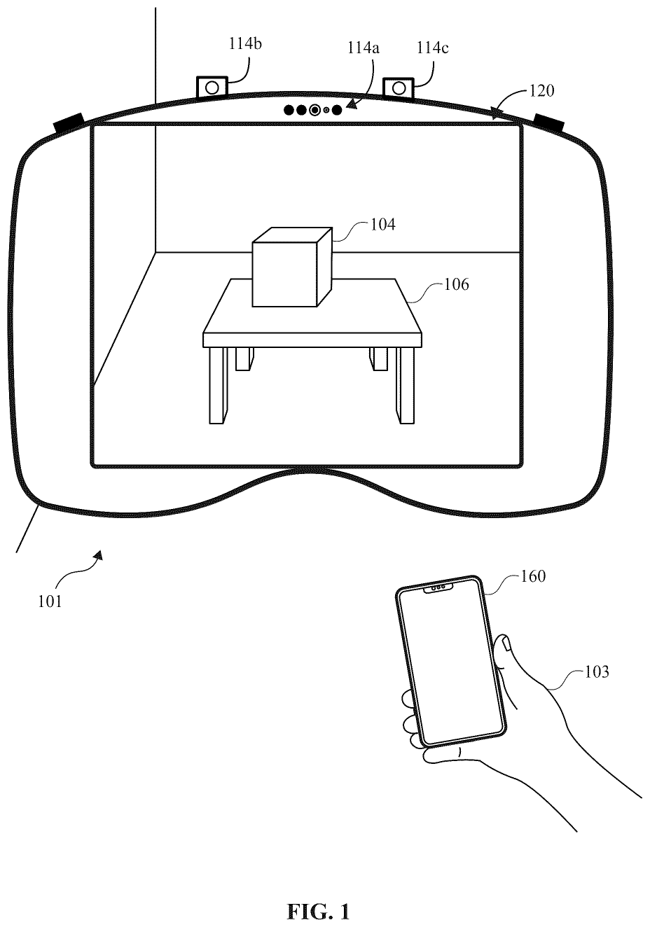

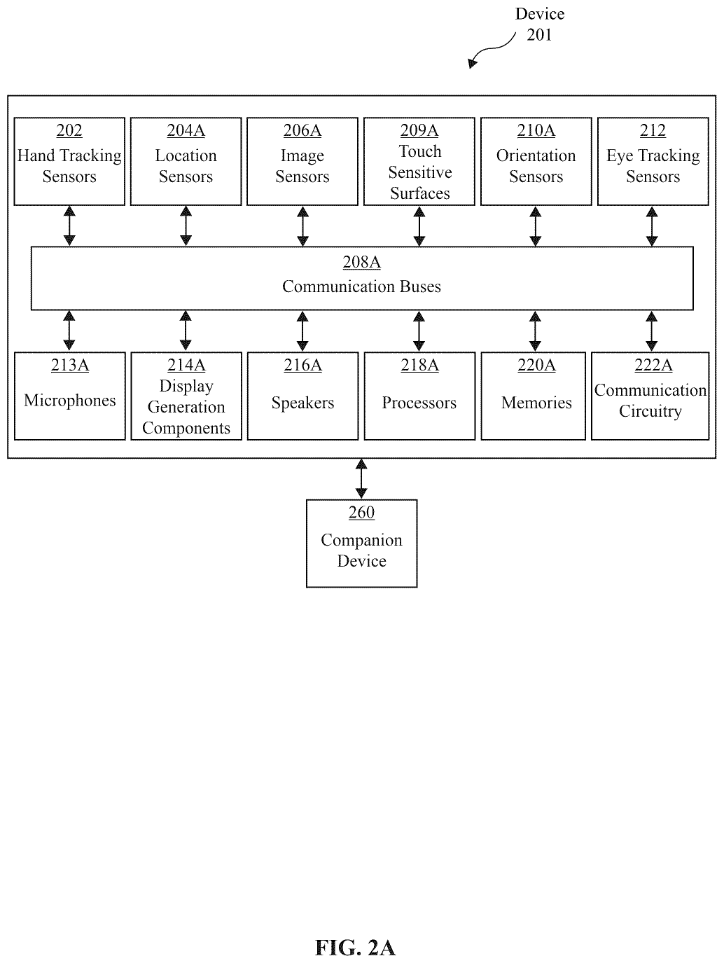

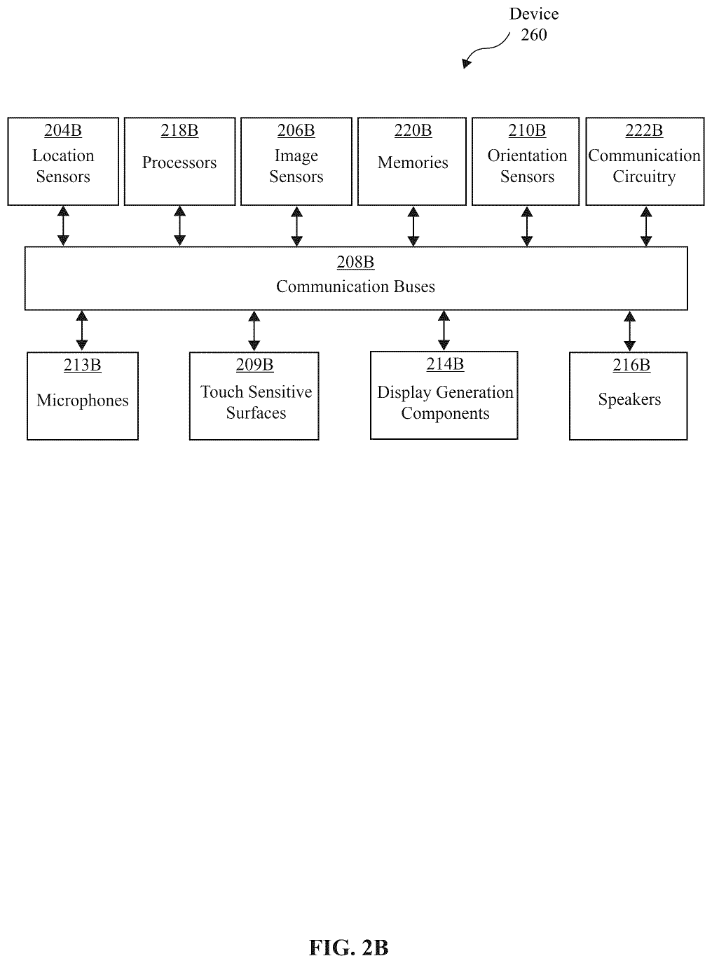

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specfies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects (e.g., a representation of a content item) that are displayed in a three-dimensional environment (e.g., an extended reality environment) presented at an electronic device (e.g., corresponding to electronic device 201). A content item, as used herein, includes any content that can be displayed, such as images (e.g., photos, graphics, etc.), videos (television shows, movies, livestreams, etc.), user interface elements, and the like. Examples of the disclosure are directed to improving the user experience by automatically manipulating the display of the representation of the content item in response to detecting movement of the electronic device when certain conditions are satisfied, which causes the portion of the physical environment, the three-dimensional environment, and/or the representation of the content item displayed via the display generation component to be updated in accordance with the movement of the electronic device.

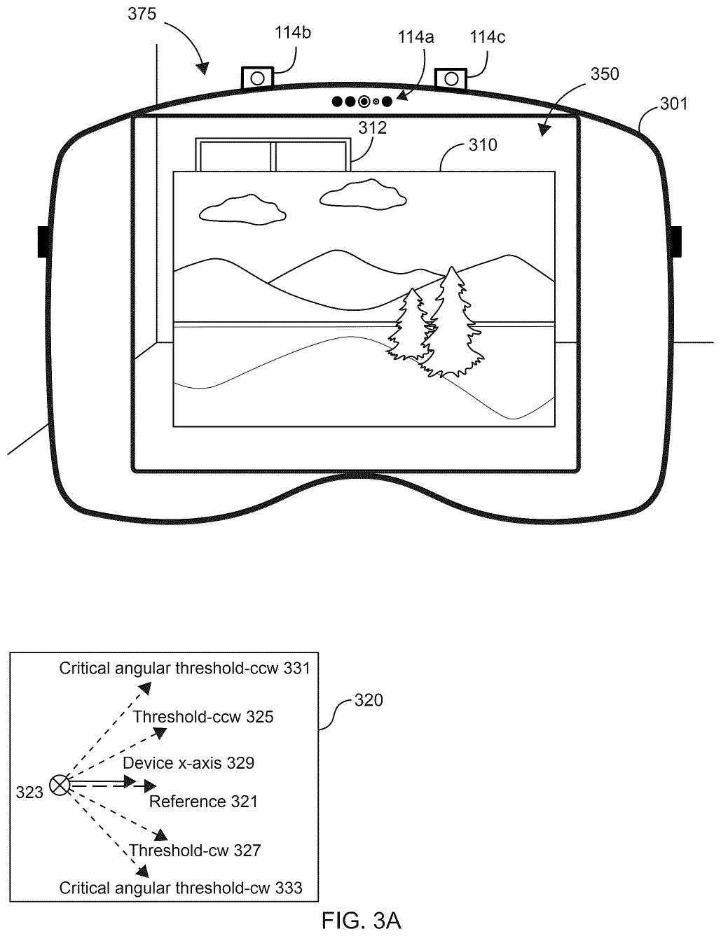

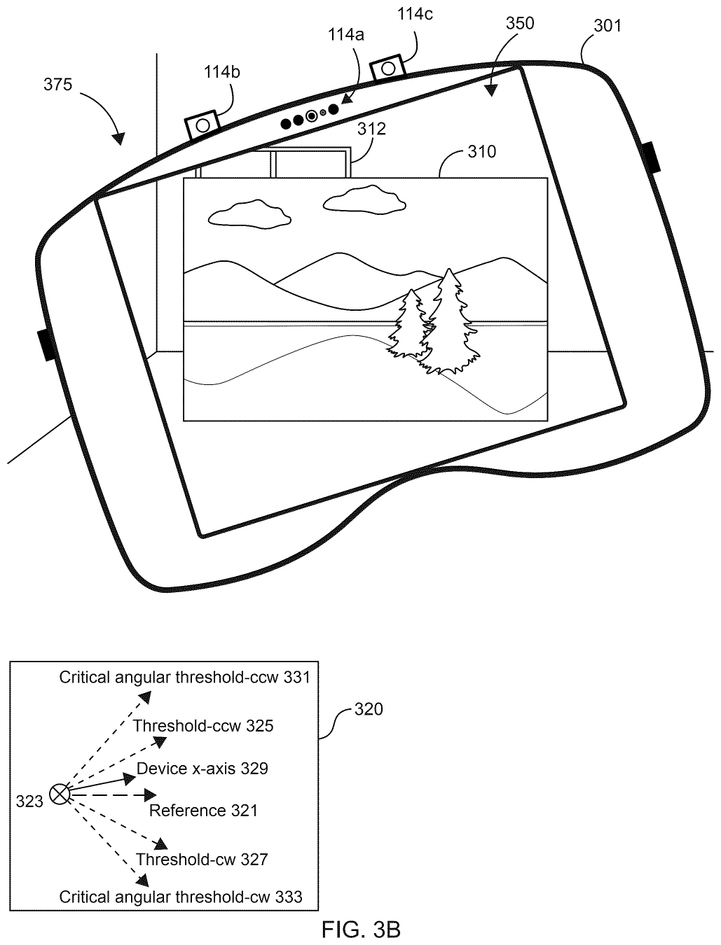

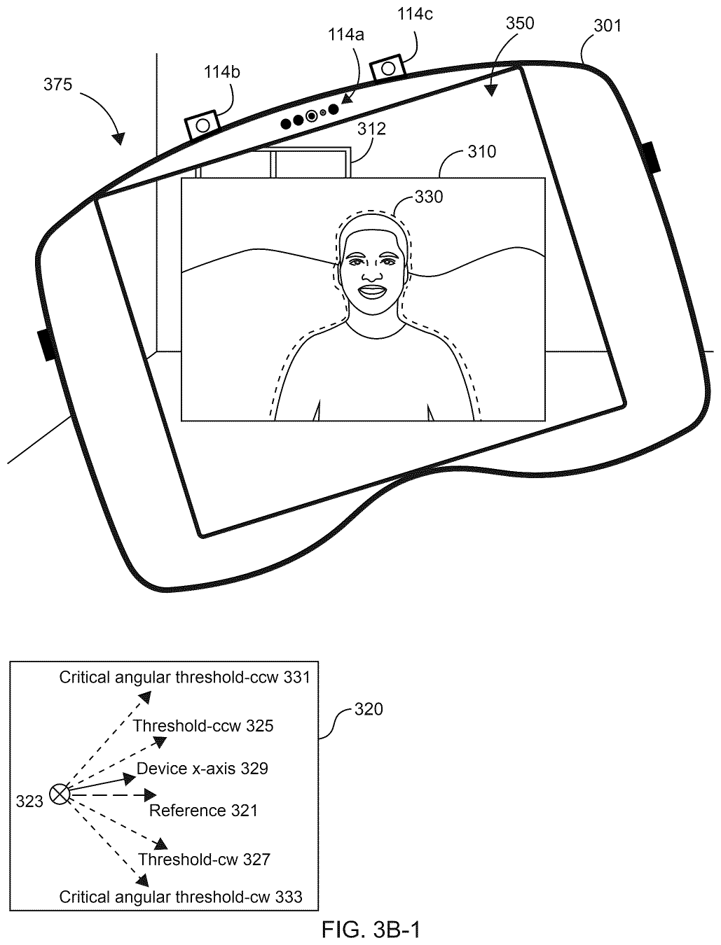

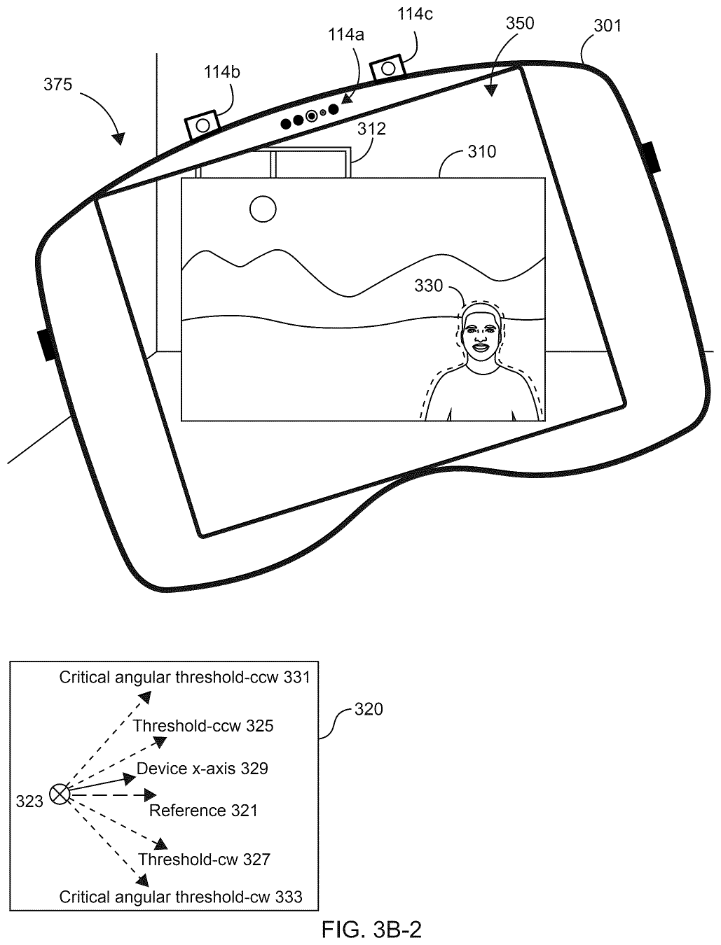

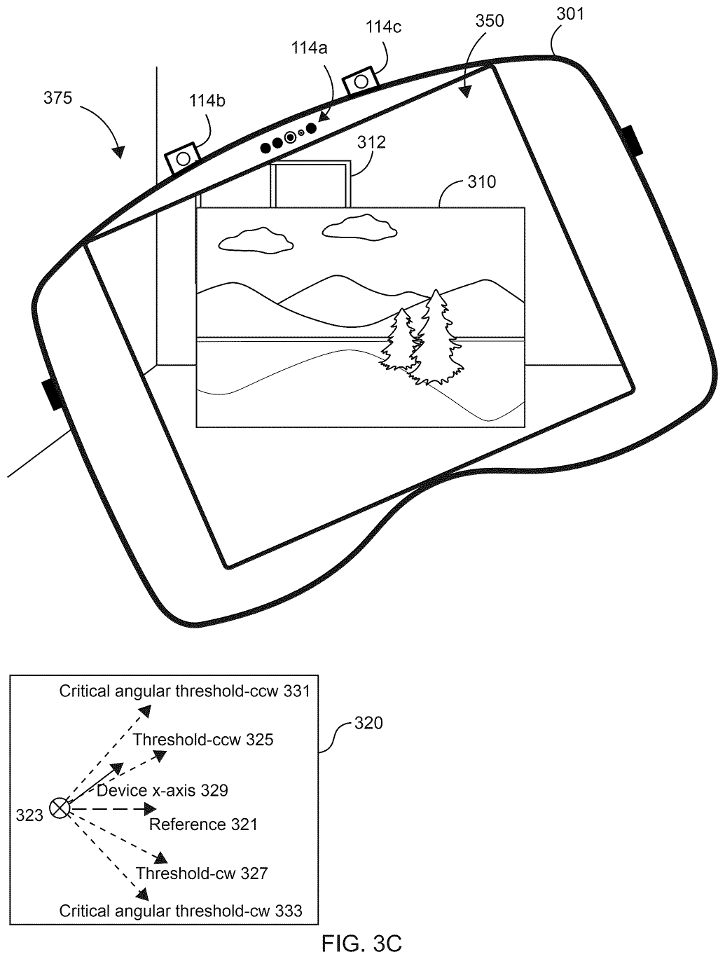

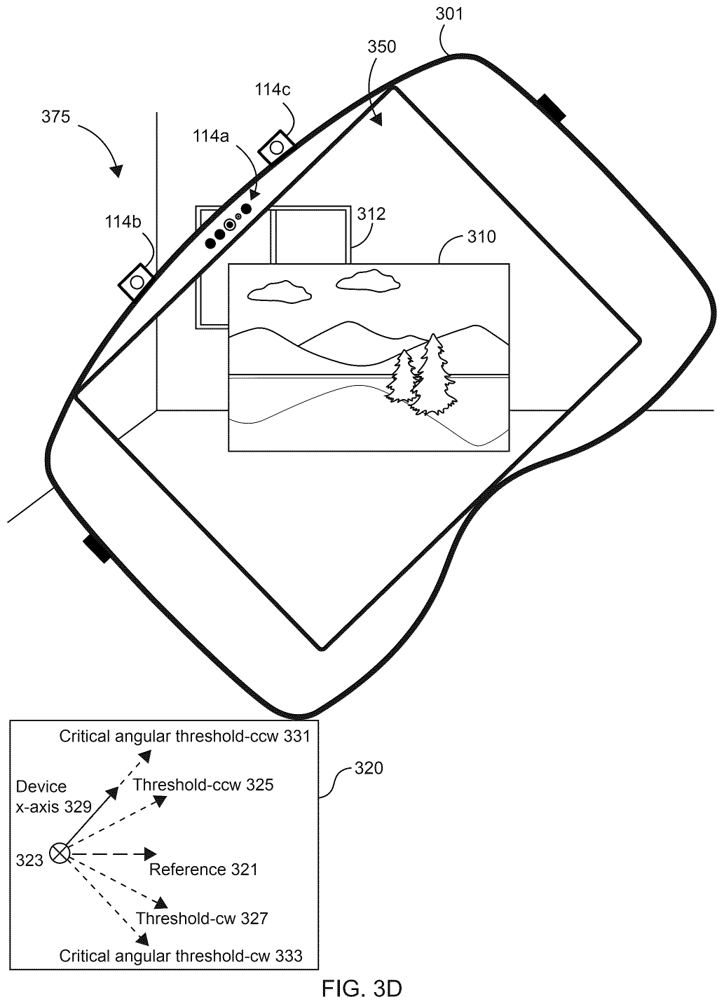

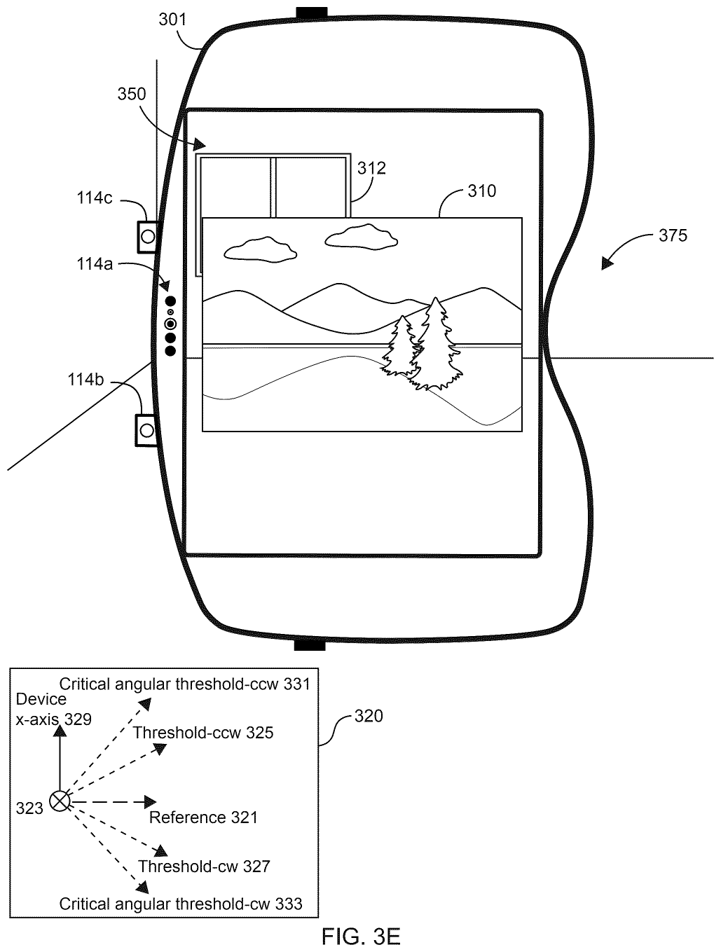

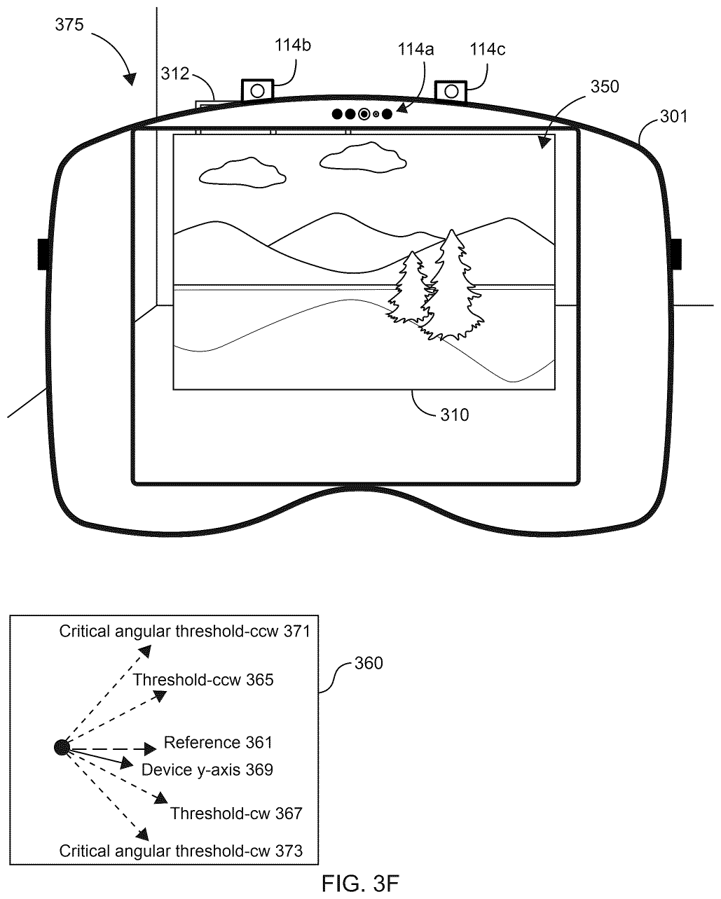

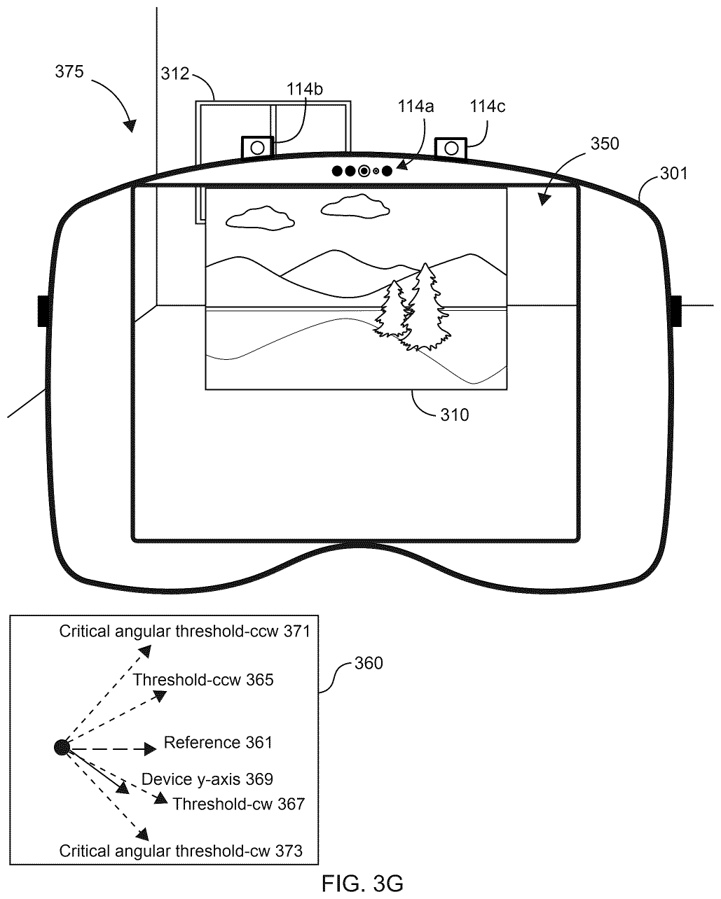

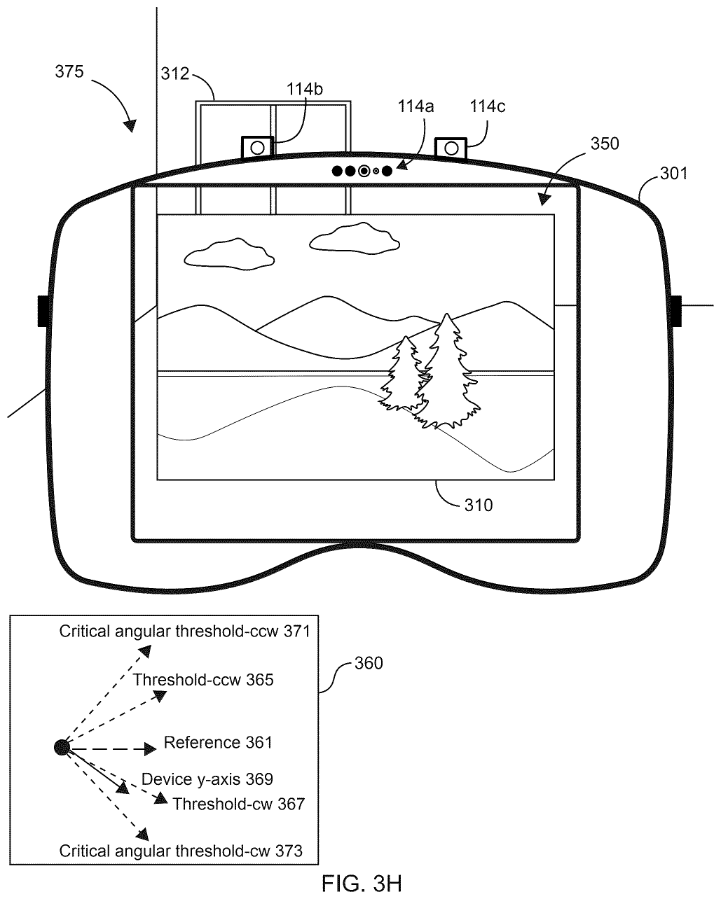

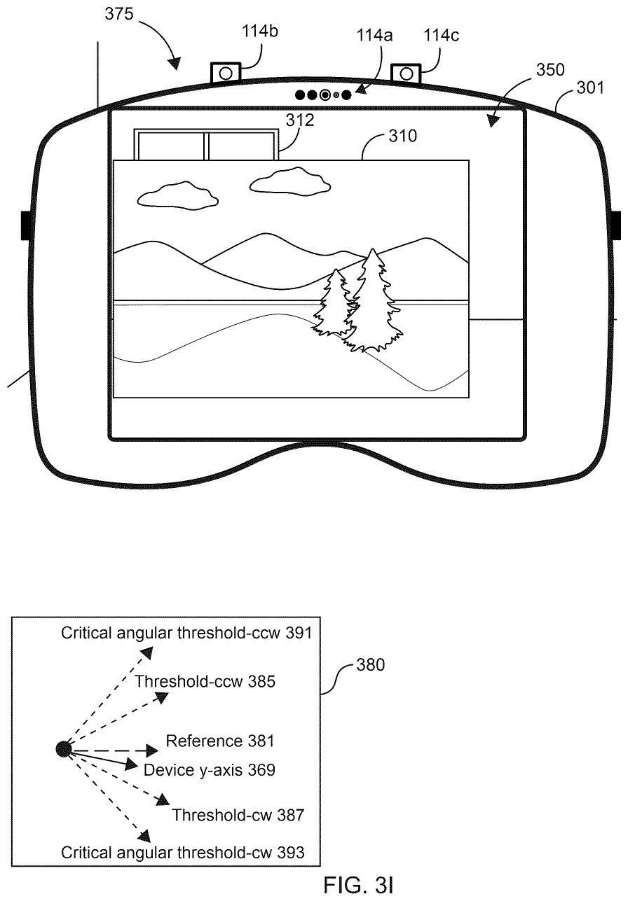

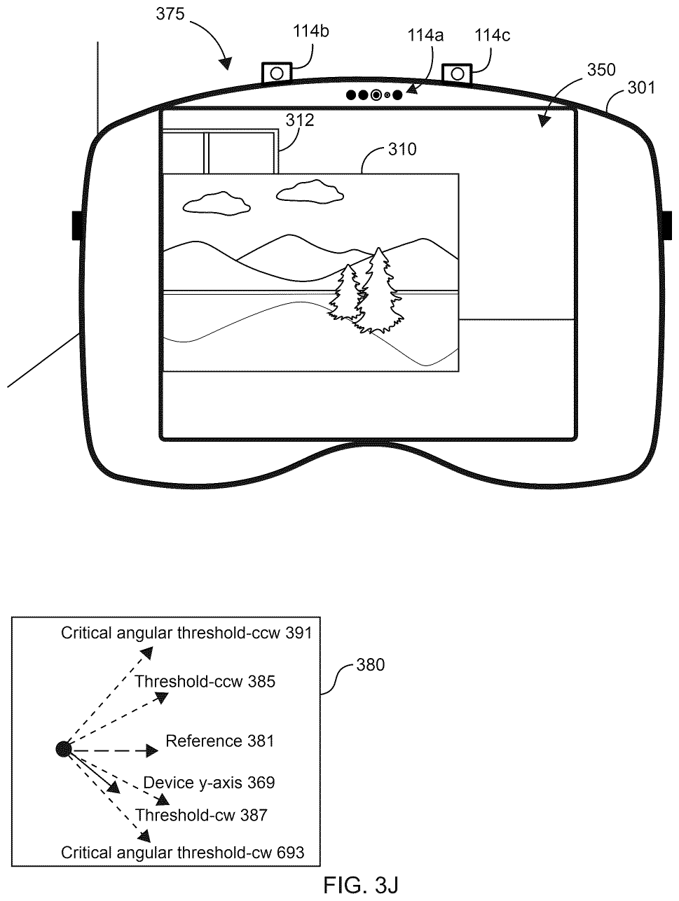

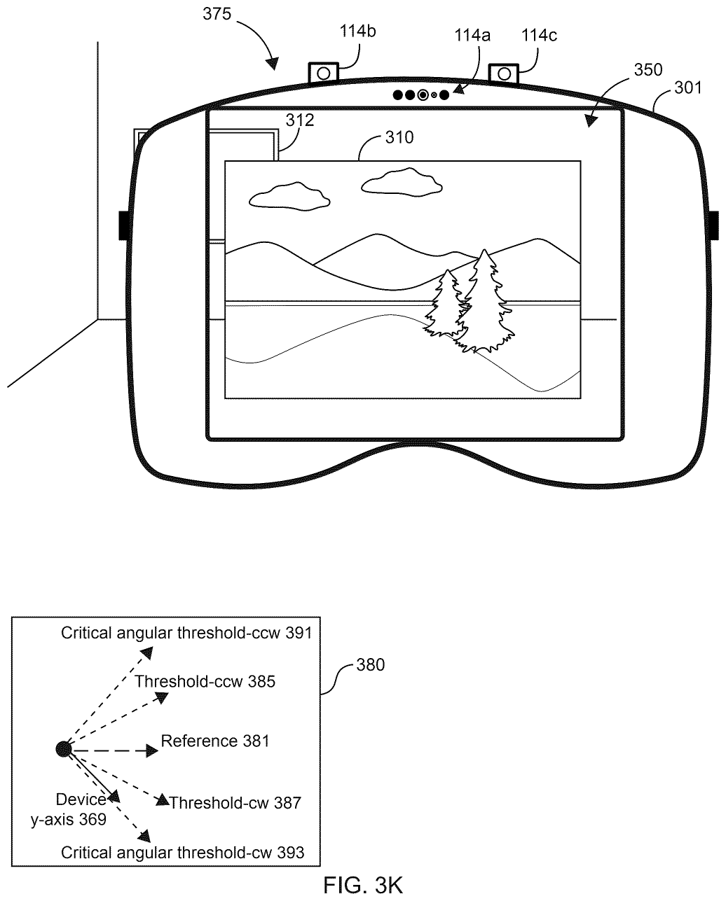

FIGS. 3A-3K illustrate an electronic device displaying a representation of a content item according to some examples of the disclosure. The electronic device 301 may be similar to electronic device 101 or 201 discussed above, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, or displays formed as lenses designed to be placed on a person's eyes (e.g., similar to contact lenses). In the example of FIGS. 3A-3E, a user is optionally wearing the electronic device 301 in a three-dimensional environment 350 that can be defined by X, Y and Z axes as viewed from the perspective of the electronic device (e.g., a viewpoint associated with the user of the electronic device 301). The electronic device 301 can be configured to be movable (e.g., with six degrees of freedom) based on the movement of the user (e.g., the head of the user), such that the electronic device 301 may be moved in the X, Y or Z directions, the roll direction, the pitch direction, and/or the yaw direction. Although X, Y, and Z directions are described, electronic device 301 may use any suitable coordinate system to track the position and/or orientation of electronic device 301. In some examples, the electronic device 301 can be located within a region of an indoor environment (e.g., in a specific room). In some examples, the electronic device can be moved into a new region within the indoor environment (e.g., into a different room). In some examples, the field of view of the one or more cameras of the electronic device 301 updates as the electronic device is being moved. Although the examples of FIGS. 3A-3E illustrate example counterclockwise rotations of electronic device 301 and updates to the content item 310 responsive to the rotations, in other examples the electronic device can be rotated clockwise with similar updates to the content item.

FIG. 3A illustrates an electronic device that is displaying a representation of a content item, but has not yet made any movements (e.g., and/or detected any movements), and has not satisfied any criterion associated with updating the representation of the content item 310 according to some examples of the disclosure. As shown in FIG. 3A, the electronic device 301 may be positioned in a physical environment (e.g., an indoor environment) that includes a plurality of real-world objects. In the example of FIG. 3A, the electronic device 301 may be oriented toward physical objects within the indoor physical environment 375, such as window 312, and may present representations of the physical objects. In some examples, the three-dimensional environment 350 presented using the electronic device 301 optionally includes captured portions of the physical environment 375 surrounding the electronic device 301. In some examples, the field of view of the user may be a subset of the field of view of the one or more cameras, and the field of view of the one or more cameras can encompass a larger portion of the three-dimensional environment 350 than the field of view of the user. In other examples, the field of view of the user can be equivalent to the field of view of one or more transparent or translucent displays, and a portion of the three-dimensional environment 350 may be presented in the field of view of the one or more transparent or translucent displays. Accordingly, although in some instances the visible field of view presented to the user in the electronic device may be described herein as being provided by one or more cameras (e.g., of the electronic device 301), it is understood that the presented field of view is not so limited, and that the field of view can alternatively be based on the field of view of one or more translucent or transparent displays. Therefore, in some examples, the representations of the physical objects in the field of view of one or more cameras can include portions of a physical environment viewed through a transparent or translucent display of electronic device 301.

In some examples, the electronic device 301 may display the representations of the content item 310 and evaluate one or more criteria associated with updating the representation of the content item 310 in all indoor environments, only in limited indoor environments (e.g., a home or an office), or only in certain rooms in a home or an office. In other examples, the electronic device 301 may display representations of content items and evaluate one or more criteria associated with updating the representation of the content item 310 in other indoor environments, such as a hotel room, a friend's home, a non-public space, and the like, or outdoor environments.

The representation of the content item 310 may display the associated content item with a scale that is predetermined via system settings or user preferences. In some examples, the content item can be so-called “playing content” such that the display consistently updates the content being presented. In some examples, the playing content item being presented can be a movie, a series, a television show, a music video or any other content item that includes visual content. In some examples, the representation of the content item may be a user interface element of a currently executing application that includes visual content. In other examples, the representation of the content item may not include playing content, and instead can be an image (e.g., a photo) captured or downloaded on the electronic device 301.

In some examples, the displayed representation of the content item 310 occupies a portion of the three-dimensional environment 350 and possesses an initial size and/or a first visual state (e.g., upon receiving a request to launch, or upon automatically launching the representation). As shown, the representation of the content item 310 has a rectangular shape. It should be understood that, in some examples, the representation of the content item 310 may have a circular shape or other shapes that are applicable to the type of content being displayed. In some examples, the initial size of the representation of the content item may be predetermined according to system settings. Alternatively, the first visual state and/or initial size for the representation of the content item can be customized and/or personalized to user preferences, needs, and/or intentions.

In some examples, the user, the electronic device, and/or the one or more physical objects in the indoor or outdoor physical environment may move about in the indoor or outdoor physical environment. In some examples, the electronic device detects the movement of the device itself, one or more physical objects in the indoor or outdoor physical environment, and/or the user, and upon detection of such movements, causes the field of view of the one or more cameras (including the representations of the one or more physical objects in the field of view of the one or more cameras) to change. In accordance with the changing field of view, previously non-visible physical objects can optionally become visible in the changed field of view.

In some examples, the display of the content item 310 can be adjusted in size (e.g., decreased or increased in size) or angle (e.g., an updated orientation of the content item with respect to the orientation of the electronic device in response to shifts in the angle or the orientation of the electronic device).

In some examples, presenting one or more content items 310 can be tied to and/or associated with a respective predetermined and/or user-defined location in the physical environment 375 or a respective physical object in the physical environment 375, such that presenting the one or more content items only occurs when the respective location in the physical environment 375 or the respective physical object in the physical environment 375 is visible in the field of view of the one or more cameras of the electronic device, and/or the electronic device is within a distance threshold from the respective predetermined and/or user-defined location in the physical environment 375 or within the distance threshold from the respective physical object in the physical environment 375. Changes to the presentation of the one or more content items (e.g., decreased or increased area, aspect ratio, etc.) can be a function of distance between the electronic device 301 and the associated predetermined and/or user-defined location and/or physical object while the one or more content items are fixed in place.

Alternatively, in some examples, in response to the detection of the movement of either the electronic device 301 and/or user, the one or more content items 310 may dynamically update and/or move in accordance with the detected movements such that the one or more content items maintain their presentation within the three-dimensional environment 350. In some examples, in response to the detection of movement of the electronic device 301 and/or user, one or more content items can transition from being presented in a first visual state to a second visual state, different from the first visual state, in the three-dimensional environment 350. In some examples, a transition of a content item may be made with a time delay (e.g., 0.5 or 1 second) to maintain the impression of a responsive content item while avoiding potential user dizziness from more instantaneous visual feedback. In general, the display of a content item can transition from a first visual state to a second visual state. In some examples, the content item is Picture in Picture (PiP) content. Although not shown in the example of FIG. 3A, as PiP content, the representation of a content item 310 is optionally displayed in a smaller size that optionally partially or fully covers a larger content item, different from the representation of the content item 310.

In some examples, the electronic device 301 selectively changes the visual state of the representation of the content item 310 in the three-dimensional environment 350 based on movement of the electronic device. For example, in FIG. 3A, the representation of the content item 310 may be tilt-locked (as defined above) in the three-dimensional environment 350. In some examples, because the representation of content item 310 is tilt-locked (e.g., displayed at a fixed orientation relative to the three-dimensional environment), the representation of content item 310 may not be repositioned in the three-dimensional environment 350 in accordance with the movement of the electronic device 301 (e.g., clockwise or counterclockwise roll movement of the device). In some examples, the representation of the content item 310 may be viewed as counter-rotating in a direction opposite to the rotation of the electronic device to offset the rotation of the electronic device and maintain its fixed orientation with respect to the three-dimensional environment 350. As mentioned above, in some examples, the electronic device 301 transitions between displaying the representation of the content item 310 in a first visual state in the three-dimensional environment 350 to displaying the representation of the content item 310 in a second visual state, different from the first visual state, in response to a determination that one or more criteria associated with updating the representation of the content item 310 has been satisfied (e.g., detecting movement of the electronic device 301 beyond a movement threshold (e.g., an angular threshold)), as discussed in more detail below. In some examples, if the electronic device 301 determines that the one or more criteria associated with updating the representation of the content item 310 has not been satisfied, the electronic device 301 maintains display of the representation of the content item 310 in the first visual state.

In some examples, determining that one or more criteria have been satisfied can cause an automatic update of the representation of the content item 310 to improve the user experience by nimbly displaying desired content items in an updated view with minimal user input (e.g., without making a gesture, navigating a user interface, pressing a button, etc.). Several nonlimiting example criteria associated with updating the representation of the content item 310 will now be discussed. In the example of FIG. 3A, one or more criteria associated with updating the representation of the content item 310 may include a criterion that is satisfied when the movement of the electronic device 301 is at or above a movement threshold. In some examples, if the movement of the electronic device 301 exceeds the movement threshold, the electronic device 301 may transition from displaying the representation of the content item 310 in a first visual state to displaying the representation of the content item 310 in a second visual state, different from the first visual state. As shown in the legends of FIGS. 3A-3E, in some examples, a reference ray 321 against which the movement threshold is measured corresponds to a ray that is both normal to force of gravity and also normal to a ray 323 that is also normal to the force of gravity and extends away from the electronic device 301 to a point on the horizon of the physical environment in the field of view of the user (e.g., the ray 323 is directed “into the page” from the perspective of FIG. 3A). As shown in the legends of FIGS. 3A-3E, the reference ray 321 against which the movement threshold is measured corresponds to a ray pointing generally to the right and parallel to the x-axis 329 of the electronic device 301. Thus, the reference ray 321 is independent of the orientation of the electronic device 301 in the three-dimensional environment 350.

In other examples, the reference ray 321 against which the movement threshold is measured is established from a calibration of the electronic device 301. For example, when the content is first launched on the electronic device 301 (e.g., such as in FIG. 3A after prior user interaction that corresponds to a request to launch the content associated with the representation of content item 310) or at some other time during operation, the electronic device 301 may prompt the user (e.g., visually (e.g., via visual cues, such as textual cues) and/or aurally (e.g., via audio output)) to face forward and look straight ahead in the three-dimensional environment 350, because a user's natural (e.g., comfortable) forward-facing head tilt (e.g., along one or both of the “tilt” and “roll” axes) may not necessarily be normal to gravity and parallel to the horizon. When the user has complied, the user can provide input to the electronic device 301 to set the reference ray 321 to be parallel to the x-axis 329 of the electronic device (but not necessarily parallel to the horizon). In other examples, the user may, at any time or after other prompts (but not necessarily prompts to face forward and look straight ahead), provide input to the electronic device 301 to set the reference ray 321 to be parallel to the x-axis 329 of the electronic device, regardless of the current orientation of the electronic device. This can allow, for example, a user to set the reference ray 321 to be parallel to the x-axis of the electronic device 301 even when the device is severely tilted with respect to the horizon of the three-dimensional environment 350, such as while oriented in a side-sleeping position (e.g., rolled severely to the left or right, etc.).

In some examples, the movement threshold corresponds to an angular movement threshold. In some examples, the angular movement of the electronic device 301 can exceed a counterclockwise angular movement threshold (Threshold-ccw) 325 or a clockwise angular movement threshold (Threshold-cw) 327 if the electronic device 301 detects a sufficient change (e.g., more than 3, 5, 8, 10, etc. degrees) in the angle between the x-axis 329 of the electronic device 301 and the reference ray 321 (e.g., illustrated in the legend 320). Exceeding the angular movement threshold in either roll direction (e.g., either clockwise or counter-clockwise relative to the reference ray 321) can trigger a transition from displaying the representation of the content item 310 in a first visual state to displaying the representation of the content item 310 in a second visual state, different from the first visual state.

In other examples, the angular movement threshold does not distinguish between angular directions, but rather corresponds to the magnitude of polar degrees relative to the reference ray 321. For example, an angular movement threshold can be set to the magnitude of 10 polar degrees relative to the reference ray 321 in legend 320. In this example, a 10 degree clockwise roll relative to the reference ray 321 (e.g., −10 polar degrees relative to the reference ray) or a 10 degree counter-clockwise roll (e.g., +10 polar degrees relative to the reference ray) can satisfy the angular movement threshold because the magnitude of the polar degrees in both scenarios is 10 polar degrees. In other words, if the electronic device 301 detects angular movement of the electronic device 301 in either roll direction relative to the reference ray having a magnitude larger than the angular movement threshold, it can be determined that the movement of the electronic device 301 exceeds the angular movement threshold.

It should be understood that, in some examples, an overall movement threshold can be established that may include the angular movement threshold and/or additional or alternative thresholds, such as distance thresholds, time thresholds, speed thresholds, acceleration thresholds, jerk thresholds, or movements in other directions relative to the ray (e.g., yaw, pitch, or roll), etc. In accordance with a determination that the angular movement threshold and any other additional or alternative thresholds have been satisfied (e.g., exceeded), the electronic device 301 can trigger a transition from displaying the representation of the content item 310 in a first visual state to displaying the representation of the content item 310 in a second visual state, different from the first visual state. However, in accordance with a determination that the angular movement threshold and any other additional or alternative thresholds have not been satisfied, the electronic device 301 does not transition to displaying the representation of the content item 310 in the second visual state.

FIG. 3B illustrates an electronic device that has moved (e.g., rotated) in the physical environment (relative to the example of FIG. 3A), but the one or more criteria associated with updating the representation of the content item 310 has not been satisfied according to some examples of the disclosure. As shown in FIG. 3B, the electronic device 301 has rotated from its previous location in FIG. 3A, but remains positioned in the physical environment (e.g., an indoor environment) that includes a plurality of real-world objects. In the example of FIG. 3B, the electronic device 301 has changed its orientation to be directed at an angle with respect to window 312 that is different from the angle in FIG. 3A (e.g., the electronic device 301 has moved +5 polar degrees counter-clockwise relative the reference ray 321 in legend 320), thereby changing the field of view of its display as provided by one or more of its cameras. Accordingly, in some examples, the electronic device 301 can present one or more updated representations of the physical objects based on the updated field of view provided by the one or more cameras or based on the updated field of view of the one or more translucent or transparent displays.

In some examples, the one or more criteria associated with updating the representation of the content item 310 may include a content type criterion that is satisfied when the type of content corresponds to a predetermined type of content item (e.g., a movie, television show, or a playing content item). In the example of FIG. 3B, movement of the electronic device 301 is detected (e.g., device 301 has rotated) and the movement threshold has been satisfied, but the content type criterion is yet to be satisfied because the content item that is represented through the representation of the content item 310 is not a predetermined type of content item (e.g., the content item associated with the representation of content item 310 is a non-playing or static picture). Therefore, the representation of the content item 310 may not transition from a first visual state to a second visual state. In some examples, the one or more-criteria associated with updating the representation of the content item 310 may include a criterion that is satisfied when the type of content orientation corresponds to a predetermined type of content orientation (e.g., a tilt-locked orientation or a head-locked orientation). In general, even though movement of the electronic device 301 may satisfy movement criteria for updating the representation of the content item 310, the electronic device may not trigger the transitioning of the display of the representation of the content item from a first visual state to a second visual state if one or more other criterion associated with updating the representation of content item 310 have not been satisfied.

FIG. 3B-1 illustrates an electronic device that differs from the example of FIG. 3B in that it displays a representation of content item 310 that includes a visual cue according to some examples of the disclosure. In some examples, the one or more criteria associated with updating the representation of the content item 310 may include a visual cue criterion that is satisfied when the electronic device 301 determines that the associated content includes a predefined visual cue. Visual cues can include an identified person, man-made objects (e.g., specific buildings or physical structures), or a naturally occurring object (e.g., a geographic location or object), For example, if the content item is a photo that captured one or a group of faces, and one or more of those faces is recognized as a predefined visual cue (e.g., object 330 includes a representation of a face that is recognized by face recognition software as corresponding to a predefined visual cue), the electronic device 301 can determine that the visual cue criterion has been satisfied. As shown in FIG. 3B-1, the representation of the content item 310 can include a visual cue (e.g., object 330), and the electronic device 301 can recognize the object 330 within the representation of the content item 310 to correspond to a visual cue. (Note that although the object 330 appears to have a dashed line emphasizing the border of the object 330 in FIG. 3B-1, this depiction is merely outlining the significance of the object 330 within the representation of the content item 310 as being a recognized visual cue for purposes of explanation, but in reality the object 330 may not be displayed with such definition.)

FIG. 3B-2 illustrates an electronic device that differs from the example of FIG. 3B in that it displays a representation of content item 310 that includes a visual cue located in a predefined region of the content item (e.g., one or more border regions and/or corner regions) according to some examples of the disclosure. In some examples, as illustrated in FIG. 3B-2, satisfaction of a visual cue criterion can further require that the visual cue be located in a predefined region of the content item (e.g., one or more border regions and/or corner regions). In one specific example where the representation of the content item 310 is presented in the user's field of view, a border region included in a visual cue criterion may constitute an area between 10 degrees of visual angle and 15 degrees of visual angle from the center of the representation of the content item 310 (wherein visual angle refers to the measure of the angular size of an object or a scene as perceived by an observer's eyes). In another specific example, the border region included in a visual cue criterion may constitute an area between the outer perimeter of the representation of the content item (e.g., the representation of the content item 310) and the perimeter of a concentric rectangle having an area that is 90 percent of the area of the representation of the content item 310. In some examples, a corner section included in a visual cue criterion can include an area within a predetermined distance (e.g., 1 inch or 2 inches, or one tenth of a side of the representation of the content item 310) from each intersection of two adjacent sides of the outer perimeter of the representation of the content item 310 such that an overarching corner region included in a visual cue criterion can be defined as the sum of all four corner sections.

One advantage of the predefined region criterion is that if the visual cue (which may be assumed to be important to the user) appears in the predefined region, the updating of the content item 310 can be modified such that most or all of the representation of the content item can remain visible rather than having potentially important portions clipped, cropped, or otherwise removed from view (along with the visual cue). (Clipping or cropping, as used herein, may be interchangeably used to describe the blocking or removal of one or more corners or border areas of the content item 310 from being displayed.) For example, one or more corners or borders of the representation of the content item 310 can remain visible even after updating of the content item. Accordingly, in some examples, the combination of a recognized visual cue located in a predefined region can be referred to as an anti-clip/crop criterion. An anti-clip/crop criterion can also be advantageous when the content item 310 has a playing feature (e.g., a television show, movie, video, etc.) where it may be assumed that all portions of the content item 310 are potentially important and should not be clipped or cropped. Accordingly, in some examples, the identification of a playing feature in the content item 310 can form another basis for satisfying the anti-clip/crop criterion.

With reference to FIG. 3B-1, the visual cue criterion can remain unsatisfied if the representation of the content item 310 does not include a recognized visual cue. Similarly, with reference to FIG. 3B-2, the visual cue criterion can also remain unsatisfied if the recognized visual cue within the representation of the content item 310 is not located in one or more predefined regions (e.g., object 330 is located near the center of the representation of the content item 310 as opposed to one or more corner regions). In general, the electronic device 301 can determine that a representation of a content item does not include any recognized visual cues (e.g., one or more faces) or may include recognized visual cues that are not located in a predefined region. Accordingly, the electronic device may not transition the display of the representation of the content item 310 from a first visual state to a second visual state.

FIG. 3C illustrates an electronic device that has moved in the physical environment (e.g., rotated relative to the example of FIG. 3B), and the electronic device 301 has determined that one or more criteria associated with updating the representation of the content item 310 has been satisfied according to some examples of the disclosure. As shown in FIG. 3C, although electronic device 301 has rotated from its previous location in FIG. 3B, it remains positioned in the physical environment (e.g., an indoor environment) that includes a plurality of real-world objects. In the example of FIG. 3C, the electronic device 301 has changed its orientation from the angle in FIG. 3B (e.g., the electronic device 301 has moved an additional +5 polar degrees or counter-clockwise relative the reference ray 321 in legend 320), thereby changing the field of view of its display as provided by one or more of its cameras. Accordingly, in some examples, the electronic device 301 can present one or more updated representations of the physical objects based on the updated field of view provided by the one or more cameras or based on the updated field of view of the one or more translucent or transparent displays. The electronic device 301 can also present a representation of content item 310 that is rotated relative to the orientation of the electronic device 301 such that the content item remains in a fixed orientation relative to the three-dimensional environment.

In some examples, the one or more criteria associated with updating the representation of the content item 310 may include a size criterion that is satisfied when the initial size of the representation of the content item 310 (e.g., at the time of receiving a request to launch, or upon an automatic launch) exceeds a minimum portion (e.g., 50 percent of the user's field of view) of the representation of the content item 310. In the example of FIG. 3C, movement of the electronic device 301 is detected (e.g., device 301 has rotated), and the electronic device has determined that both a movement criterion has been satisfied, and also that a size criterion associated with the portion size of the representation of the content item 310 has been satisfied because the representation of the content item 310 has an initial size that is beyond a minimum portion of half of the user's field of view. If the satisfaction of the movement criterion and the size criterion represents the satisfaction of all criteria for updating the representation of the content item 310, the electronic device 301 can trigger a transition of the representation of the content item 310 from a first visual state to a second visual state.

In the example of FIG. 3C, as the representation of the content item 310 is tilt-locked and remains in a fixed orientation relative to the three-dimensional environment 350, once the device has rotated, the electronic device 301 will update the three-dimensional environment 350 including one or more virtual objects and one or more visual representations of one or more content items 310 to accommodate the updated field of view. In some examples, the pre-update first visual state of the representation of the content item 310 is associated with an initial size of the representation of the content item 310 (e.g., upon receiving a request to launch, or upon an automatic launching of the representation). In some examples, the transition of the representation of the content item 310 to a post-update second visual state corresponds to scaling the display of the representation of the content item to a second size, different from the initial size. In some examples, the second size is smaller than the initial size. For example, in FIG. 3C, as the electronic device 301 rotates counter-clockwise exceeding the movement threshold while satisfying the movement criterion and the size criterion, the representation of the content item 310 that is tilt-locked can scale down in size such that the entirety of the frame of the updated representation of the content item 310 remains visible in the updated field of view. Even though the content can be scaled in this example, the user would still have access to the full frame of the content item (e.g., if the content is a television show, the user can readily view the perimeter of the representation of the content item 310 without any cropping). In other examples, the initial size is smaller than the second size. For example, if the movement of the electronic device 301 in FIGS. 3A to 3C is reversed, thereby exceeding the movement threshold in the clockwise direction and also satisfying a size criterion, the representation of the content item can scale up in size such that the entirety of the frame of the updated representation of the content item 310 remains visible in the updated field of view (e.g., without cropping) and occupies a larger portion of the user's field of view.

FIGS. 3D-3E illustrate an electronic device that has continued to move in the physical environment 375 (e.g., continued to rotate counterclockwise relative to the example of FIG. 3C or the preceding figures) and has determined that one or more criteria associated with updating the representation of the content item 310 has been satisfied according to some examples of the disclosure. In the examples of FIG. 3D-3E, although electronic device 301 has rotated from its previous location in FIG. 3C, it remains positioned in the physical environment (e.g., an indoor environment) that includes a plurality of real-world objects. In the example of both FIGS. 3D-3E, the electronic device 301 has changed its orientation from the angle in FIG. 3C (e.g., the electronic device 301 has moved an additional +5 polar degrees counter-clockwise relative the reference ray 321 in legend 320), thereby changing the field of view of its display as provided by one or more of its cameras. The electronic device 301 can present a representation of content item 310 that is rotated relative to the orientation of the electronic device 301 such that the content item remains in a fixed orientation relative to the three-dimensional environment.

In some examples, the representation of content item 310 may continue to transition to additional visual states as the electronic device 301 continues to make movements after exceeding an initial movement threshold, and while one or more criteria associated with updating the representation of the content item remains satisfied. For example, the electronic device 301 can undergo additional counter-clockwise movements in FIG. 3C, ultimately reaching the state depicted in FIG. 3D. Accordingly, the representation of the content item 310 can continue to transition to new visual states as a function of movement. In some examples, additional visual state transitions can occur after further movement of the electronic device 301 and the sequential satisfaction of one or more additional movement thresholds. For example, the representations of the content item 310 in FIGS. 3C and 3D can correspond to consecutively updated visual states. In this example, the angular movement of the electronic device 301 from its orientation in FIG. 3C to its subsequent orientation in FIG. 3D may cause only one additional movement threshold to be satisfied for triggering the transition of the representation of the content item 310 to an updated visual state. However, if the electronic device 301 starting from FIG. 3C does not detect sufficient movement to reach the angle depicted in FIG. 3D and trigger an additional movement threshold, the representation of the content item 310 may not transition to a new visual state. Alternatively, in other examples, additional visual state transitions of the representation of the content item 310 can appear to be continuous in nature, with the electronic device 301 detecting the satisfaction of numerous smaller movement thresholds and causing a transition through numerous visual states.

In some examples, if the direction of movement is maintained, the angular rotation of the electronic device 301 (e.g., angular rotation relative to the reference ray 321) may reach a critical angular threshold (e.g., +45 polar degrees relative to the reference ray), different from the aforementioned one or more angular movement thresholds, that limits any further updates to the representation of the content item 310. For example, after the electronic device 301 reaches its orientation in FIG. 3D, the electronic device 301 can reach the critical angular threshold-ccw 331 in FIG. 3E. In this example, the electronic device 301 may rotate further counter-clockwise to reach its orientation in FIG. 3E, but because the critical angular threshold-ccw 331 has been satisfied, additional rotation will not trigger the representation of the content item 310 to further scale down (e.g., will not trigger further updates to the representation of content item 310). In some examples, any rotations beyond the critical angular threshold-ccw 331 can reverse prior updates to the representation of the content item 310. Similar limits on updating the representation of the content item 310 can be implemented for clockwise rotations of the electronic device 301 using a critical angular threshold-cw 333. In other examples, a critical angular threshold can be established when the magnitude of the rotation of the electronic device exceeds a threshold, regardless of whether the rotation was clockwise or counterclockwise.

In some examples, the one or more criteria associated with updating the representation of the content item 310 may include a criterion that is satisfied when a context of the three-dimensional environment corresponds to predetermined context (e.g., lack or decrease of movement of the electronic device 301, or lack or decrease of user interaction with a user interface for a period longer than a time delay (e.g., 5, 10, 15 seconds, etc.), detecting the user taking a seat, etc.). Although not explicitly shown in the figures, the user may desire to focus back on the representation of the content item 310 after movement of the electronic device 301, and detecting the satisfaction of a predetermined context criterion can trigger an update to the representation of the content item 310 that facilitates that renewed focus. User focus on a given representation of content item 310 may be achieved through reduction or ceasing of user interaction with other content items or reduction or ceasing of user and/or electronic device movements. In some examples, various sensors in the electronic device 301 can detect the reduced (or a lack of) user interaction with content items or reduced (or a lack of) movement of the electronic device, and start a timer or other elapsed time mechanism. When a threshold time is satisfied, the representation of the content item 310 can be updated. For example, the electronic device 301 can cause the representation of the content item 310 to update and revert back to its initial (e.g., larger) size or to enlarge the frame of the representation of the content item 310 to fit the widest possible aspect ratio with maximum visibility for the representation of the content Item 310.

The preceding examples of the electronic device primarily focused on roll movements and the corresponding behavior of the electronic device with respect to the example of FIG. 3A. Several nonlimiting examples associated with movements of the electronic device in the pitch and/or yaw directions and corresponding behavior of the electronic device will now be discussed. FIG. 3F illustrates an electronic device that has moved (e.g., tilted) in the physical environment (relative to the example of FIG. 3A), but the one or more criteria associated with updating the representation of the content item 310 has not been satisfied according to some examples of the disclosure. As shown in FIG. 3F, the electronic device 301 has tilted from its previous location in FIG. 3A, but remains positioned in the physical environment (e.g., an indoor environment) that includes a plurality of real-world objects. In the example of FIG. 3F, the electronic device 301 has tilted in the pitch direction, as described above (e.g., the electronic device 301 has moved +5 polar degrees clockwise relative the reference ray 361 in legend 360), thereby changing the field of view of its display as provided by one or more of its cameras, and, as a result, presenting one or more updated representations of the physical objects based on the updated field of view provided by the one or more cameras or based on the updated field of view of the one or more translucent or transparent displays.

In some examples, while no user inputs for moving or exiting out of the representation of the content item 310 in the displayed three-dimensional environment 350 are detected, the electronic device 301 can continue to present the representation of the content item 310 at a predetermined and/or user-defined location in the physical environment 375 indefinitely. In these examples, movements of the electronic device may cause updates to the representation of the content item 310; however, the presentation of the representation of the content item 310 can occur as long as the predetermined and/or user-defined location in the physical environment 375 remains visible in the field of view of the one or more cameras of the electronic device 301. In some examples, the movement of the electronic device may not necessarily cause updates to the content item 310. For example, as shown in FIG. 3F, the electronic device has tilted in the pitch direction, but the representation of the content item 310 remains presented according to the same placement relative to the physical environment 375 and the same size and shape as shown in FIG. 3A.

In some examples, the representation of the content item 310 is head-locked, tilt-locked, and/or horizon-locked, as defined above, optionally with elasticity. For example, when the representation of the content item 310 is head-locked with elasticity, electronic device 101 optionally causes the representation of the content item 310 to visually behave as head-locked content in accordance with an elasticity model. In some examples, the elasticity model implements physics to the user's interaction in the three-dimensional environment 375 so that the interaction is governed by the law of physics, such by laws relating to springs. For example, the head position and/or head orientation of the user optionally corresponds to a location of a first end of a spring (e.g., simulating a first end of the spring being attached to an object) and the representation of the content item 310 optionally corresponds to a mass attached to a second end of the spring, different from (e.g., opposite) the first end of the spring). While the head position and/or orientation is a first head position and/or first orientation that corresponds to a first location of the first end of the spring and the representation of the content item 310 corresponds to the mass attached to the second end of the spring, the electronic device optionally detects head movement (e.g., head rotation) from the first head position and/or first head orientation to a second head position and/or second head orientation. In response to the detection of the head rotation, the electronic device optionally models deformity of the spring (e.g., in accordance with the amount of head rotation and/or speed of head rotation), and moves the representation of the content item 310 in accordance with release of the energy that is due to the spring's movement toward an equilibrium position (e.g., a stable equilibrium position) relative to the second head position and/or second head orientation. The speed at which the representation of the content item 310 follows the head rotation is optionally a function of the distance between the location of the representation of the content item 310 when the electronic device detects the head rotation and the location of the representation of the content item 310 that would correspond to a relaxed position of the spring (e.g., an equilibrium position), which would optionally be a location, that, relative to the user's new viewpoint resulting from the head rotation, is the same as the location of the representation of the content item 310 relative to the user's viewpoint before the head rotation is detected. In some examples, as the representation of the content item 310 moves towards to the relaxed position in response to the head rotation, the speed of the representation of the content item 310 decreases. In some examples, the head of the user is rotated a first amount within a first amount of time, and the movement of the representation of the content item 310 to its new location relative to the new viewpoint of the user is performed within a second amount of time that is greater than the first amount of time. As such, when the representation of the content item 310 is head-locked with elasticity 322, in accordance with detection of head movement, electronic device 101 optionally displays the first virtual content moving within a three-dimensional environment in accordance with the user's head movement and in accordance with an elasticity model mimicking a lazy follow movement behavior, such as shown and described with reference to FIGS. 3F-3K.

Applying elasticity behavior to horizon-locked or head-locked content is useful for smoothing out the movement of the first virtual content in the three-dimensional environment when the user moves (e.g., rotates the user's head). This smoothing can improve user experience by reducing motion sickness or dizziness from behavior without elasticity. Additionally or alternatively, a time-delay can be used instead of an elasticity model.

As shown in FIG. 3F, for example, when the electronic device 301 tilts in the pitch direction, the representation of the content item 310 can appear closer to the top side of the display (e.g., initially appearing as fixed in place relative to the three-dimensional environment 375 for a brief duration of time before getting updated in accordance with the elasticity model).

FIGS. 3G-3H illustrate an electronic device that has continued to move (e.g., tilted) in the physical environment 375 (e.g., continued to tilt in the pitch direction relative to the example of FIG. 3F or the preceding figures) and has determined that one or more criteria associated with updating the representation of the content item 310 has been satisfied according to some examples of the disclosure. In the examples of FIG. 3G-3H, although electronic device 301 has rotated from its previous location in FIG. 3F, it remains positioned in the physical environment (e.g., an indoor environment) that includes a plurality of real-world objects. In the examples of FIGS. 3G-3H, the electronic device 301 has changed its orientation from the angle in FIG. 3F (e.g., the electronic device 301 has moved an additional +10 polar degrees clockwise relative the reference ray 361 in legend 360), thereby changing the field of view of its display as provided by one or more of its cameras. The electronic device 301 can present a representation of content item 310 that may be viewed as initially sliding against movements in the pitch direction of the electronic device 301 until reaching a boundary of the user's viewpoint where the representation of the content item 310 updates to display with a different frame size and/or moves within the three-dimensional environment 375 to remain displayed within user's viewpoint.

In some examples, the representation of the content item 310 can undergo one or more updates to its visual state (e.g., shrinking size). In some examples, updates to the visual states of the visual representation of the content item 310 can include any updates to its orientation and placement relative to the three-dimensional environment 375 or any other updates without changing its orientation and placement relative to the three-dimensional environment 375. In some examples, the full frame of the visual representation of the content item 310 remains displayed within user's viewpoint unless the user provides inputs to change the locking behavior of the representation of the content item 310.

In some examples, as the one or more criteria become satisfied to cause updates to the representation of the content item 310, effective updates to the representation of the content item 310 may occur only after a time-delay and/or with lazy-follow elasticity, which can result in the representation of the content item 310 being displayed in an intermediary visual state (e.g., between the first and second visual states) where a portion of the representation of content item 310 is clipped with a portion size depending on the degree of movements in the pitch direction. In some examples, the electronic device 301 may transition from displaying the representation of the content item 310 in a first visual state to displaying the representation of the content item 310 in a second visual state, different from the first visual state, and all corners (e.g., or full frame) of the representation of the content item 310 with a second visual state remains (e.g., representation of content item 310 shrinking in FIG. 3G) visible within the bounds of the depicted three-dimensional environment 350 (e.g., or within user's viewpoint). In some examples, as shown in FIG. 3G, the second visual state of the representation of the content item 310 increases or decreases in scale to occupy the widest aspect ratio on the display without changing its center and without any clipping. In some examples, when implementing lazy-follow elasticity, the edge of the display acts as a hard edge that does not allow the content to move off-screen. In other words, whereas the content behavior with elasticity may allow for a portion of the content to be offscreen, the hard-edge behavior would lock the content to the edge of the display when the content would otherwise be off-screen according to the elasticity model. Additionally, it is understood that although a specific edge is shown in this example, that the hard-edge technique can applied to one or more edges depending on the direction of motion (e.g., upper and left edges can be hard edges for a quick lower-rightward pitch/yaw movement).

In some examples, the representation of the content item 310 and its updated versions are head-locked, tilt-locked, and/or horizon-locked, as defined above, with elasticity. In some examples, after a first instance of detecting movement (e.g., continuous movements), the electronic device 301 also detects the end of movement (e.g., the continuous lack of movements, or movements below a threshold), and the updated representation of the content item 310 moves toward an equilibrium position relative to the user's updated viewpoint after a time threshold beyond the most recent episode of inactivity. In other words, the spring behavior of the elasticity model returns to a relaxed state. In some examples, optionally in response to exceeding a time-threshold following the consistent lack of movement, the updated representation of the content item 310 may undergo a further transition into a new visual state which includes realigning with the new orientation (e.g., after any prior movements) of the electronic device 301 and/or occupying a larger portion of the field of view or reverting to its initial size from the first visual state. For example, as shown in FIG. 3H, after a series of events including the electronic device 301 continuously tilting in the pitch direction and accordingly transitioning the representation of the content item 310 into a new visual state and subsequently passing a time delay beyond a duration of post-transitional continuous lack of movement, the representation of the content item reverses its scale back up to its initial size and/or may realign or reorient within the user's updated viewpoint.

An elasticity model described herein can be a function of time and of distance. For example, a relatively increased speed of the rotational movement increases the likelihood of potential clipping (without the techniques described herein). For example, elasticity may result in content being clipped (e.g., being partially off-screen) for a first rotational movement over a first time period, whereas the elasticity may not result in clipping for a second rotational movement, greater than the first rotational movement, over a second time period greater than the first time period. For ease of illustration, FIGS. 3G-3H reference movement by angle compared with a threshold angle, but it is understood that the illustrated clipping and/or resizing behavior can be instead occurring when there is movement at a speed relative greater than a threshold speed (e.g., the threshold angle shown is relative to the time period in which clipping may occur). As shown in the legends 360 of FIGS. 3G-3H, in some examples, a reference ray 361 against which the movement threshold is measured corresponds to a ray that is both normal to force of gravity and also to the horizon of the physical environment in the field of view of the user. The reference ray 361 corresponds to a ray pointing generally to the horizon and parallel to the y-axis 369 of the electronic device 301. Thus, the reference ray 361 is independent of the orientation of the electronic device 301 in the three-dimensional environment 350. In other examples, the reference ray 361 against which the movement threshold is measured is established from a calibration of the electronic device 301. In some examples, the angular movement of the electronic device 301 can exceed a clockwise angular movement threshold (Threshold-cw) 367 or a counter-clockwise angular movement threshold (Threshold-ccw) 365 (e.g., neither thresholds 365 and 367 are normal to gravity and they generally correspond to directions of below and above the electronic device respectively) if the electronic device 301 detects a sufficient change (e.g., more than 3, 5, 8, 10, etc. degrees) in the angle between the y-axis 369 of the electronic device 301 and the reference ray 361 (e.g., illustrated in the legend 360). Exceeding the angular movement threshold in either pitch direction (e.g., either clockwise or counter-clockwise relative to the reference ray 361) can trigger a transition from displaying the representation of the content item 310 in a first visual state to displaying the representation of the content item 310 in a second visual state, different from the first visual state.

FIGS. 3I-3K illustrate an electronic device that has sequentially moved about the yaw direction (e.g., tilted) in the physical environment 375 (e.g., tilted in the yaw direction relative to the example of FIG. 3A or the preceding figures) according to some examples of the disclosure. Examples depicted in the figure series 3I-3K differ from the examples depicted in FIGS. 3F-3H in that device movements are instead around the yaw direction which is generally to the right of the electronic device. For brevity, the relevant example features and alternatives discussed with respect to preceding figures may apply to the examples depicted in FIGS. 3I-3K. For example, yaw movements of the electronic device 301 (e.g., or user movements) are detected and the user's viewpoint changes from the illustration in FIG. 3A to the viewpoint in FIG. 3I. A transition for the representation of the content item 310 is shown in FIG. 3J for scaling to avoid clipping when a portion of the content item 310 would otherwise be off-screen due to elasticity of the lazy follow behavior. As shown in FIG. 3K, reversal of scaling and/or realigning of the representation of the content item 310 with the new orientation of the electronic device occur. For example, after a time threshold without movement (or less than a threshold amount of movement or less than a threshold amount of speed to avoid clipping due to lazy follow behavior), the representation of the content item 310 resizes to its full frame size shown in FIG. 3A.

An elasticity model described herein can be a function of time and of distance. For example, a relatively increased speed of the rotational movement increases the likelihood of potential clipping (without the techniques described herein). For example, elasticity may result in content being clipped (e.g., being partially off-screen) for a first rotational movement over a first time period, whereas the elasticity may not result in clipping for a second rotational movement, greater than the first rotational movement, over a second time period greater than the first time period. For ease of illustration, FIGS. 3I-3K reference movement by angle compared with a threshold angle, but it is understood that the illustrated clipping and/or resizing behavior can be instead occurring when there is movement at a speed relative greater than a threshold speed (e.g., the threshold angle shown is relative to the time period in which clipping may occur). As shown in the legends 380 of FIGS. 3I-3K, in some examples, a reference ray 381 against which the movement threshold is measured corresponds to a ray that is both normal to force of gravity and also the horizon of the physical environment in the field of view of the user. The reference ray 381 corresponds to a ray pointing generally to the horizon and parallel to the y-axis 369 of the electronic device 301. Thus, the reference ray 381 is independent of the orientation of the electronic device 301 in the three-dimensional environment 350. In other examples, the reference ray 381 against which the movement threshold is measured is established from a calibration of the electronic device 301. In some examples, the angular movement of the electronic device 301 can exceed a clockwise angular movement threshold (Threshold-cw) 387 or a counter-clockwise angular movement threshold (Threshold-ccw) 385 (e.g., All thresholds including 385 and 387 are normal to gravity and they generally correspond to directions to the left and right of electronic device 301 respectively) if the electronic device 301 detects a sufficient change (e.g., more than 3, 5, 8, 10, etc. degrees) in the angle between the y-axis 369 of the electronic device 301 and the reference ray 381 (e.g., illustrated in the legend 380). Exceeding the angular movement threshold in either yaw direction (e.g., either clockwise or counter-clockwise relative to the reference ray 381) can trigger a transition from displaying the representation of the content item 310 in a first visual state to displaying the representation of the content item 310 in a second visual state, different from the first visual state.

In some examples, the one or more criteria associated with updating the representation of the content item 310 may include a rate of change criterion that is satisfied when the rate of change (e.g., speed, velocity, and/or acceleration) of movements (e.g., angular movements) of the electronic device 301 exceeds a threshold rate of change of movements (e.g., 0.3, 0.5, or 1 px/ms), optionally in addition to or instead of the criterion that is based on the movement threshold of the electronic device 301. For example, the electronic device 301 calculates the rate of the change of the movements and determines that a rate of change criterion has been satisfied (e.g., in addition to or instead of the movement criterion being satisfied). When the criteria for updating the representation of the content item 310 are satisfied, including the rate of change criterion, the electronic device 301 can trigger a transition of the representation of the content item 310 from a first visual state to a second visual state. For example, yaw movements of the electronic device 301 (e.g., or user movements) are illustrated by changes the user's viewpoint between FIG. 3A and FIG. 3I. When the rate of change criterion is satisfied (e.g., optionally for a threshold period of time), the representation of the content item 310 transitions into a new visual state. In some examples, the transition of the representation of the content item 310 may be proportional to the value of the rate of change of movements of the electronic device 301 (e.g., the representation of content item 310 shrinks more to provide more padding for the elasticity model or perceived lazy follow described above). Alternatively, regardless of the value of the rate of change of movements of the electronic device 301, the new visual state of the representation of the content item is predetermined and/or user defined according to one or more visual characteristics.

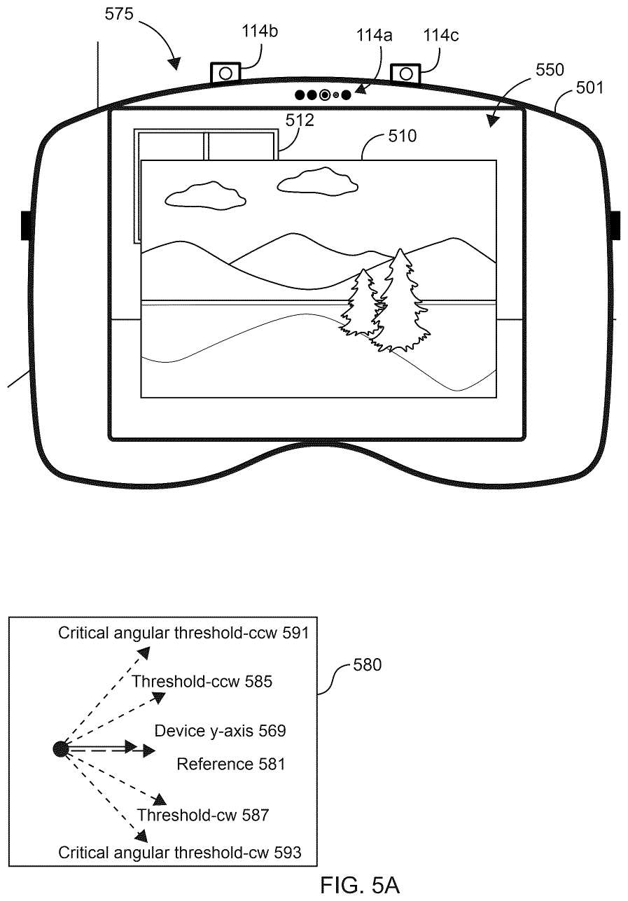

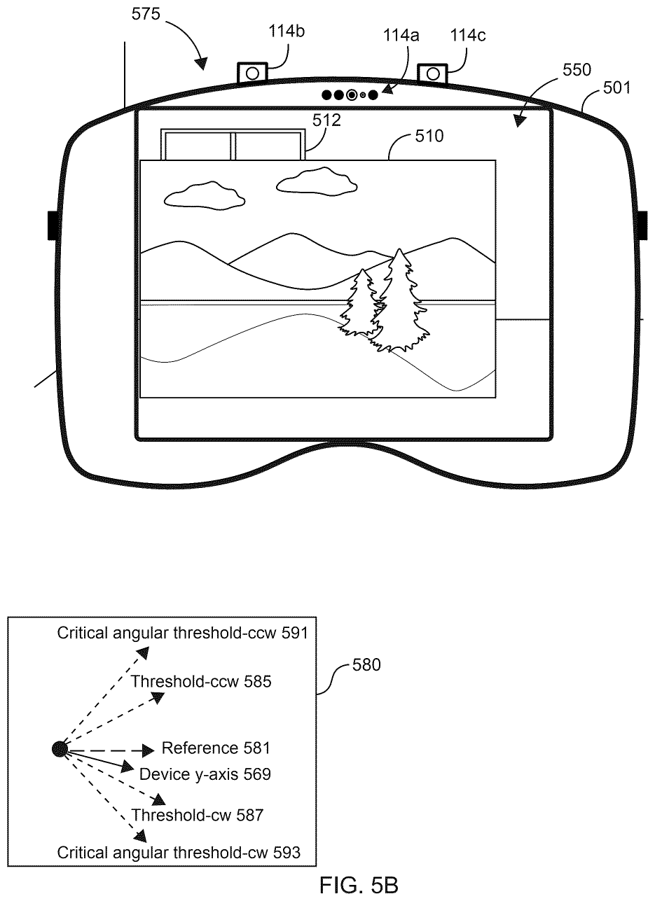

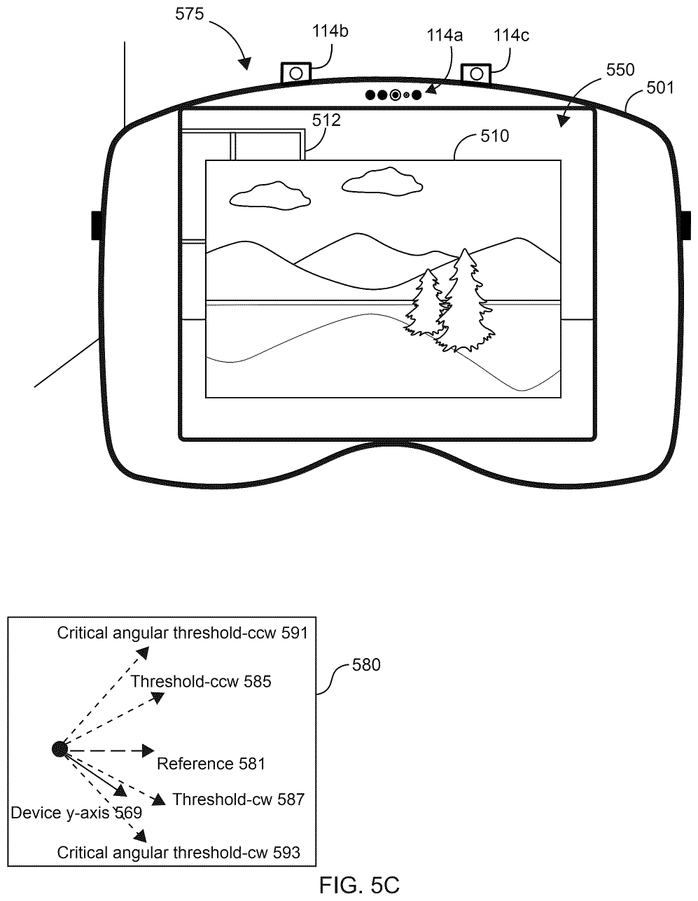

FIGS. 5A-5C illustrate an electronic device that has sequentially moved about the yaw direction (e.g., tilted) in the physical environment 575 (e.g., tilted in the yaw direction) according to some examples of the disclosure. Examples depicted in the figure series 5A-5C differ from the examples depicted in FIGS. 3A and 3I-3K in that the representation of the content item is generally presented without any cropping, clipping, and/or scaling. In some examples, the representation of the content item tracks the movements of the electronic device 301. Optionally, the representation of the content item tracks the movements of the electronic device after a time-delay while maintaining its presentation within the bounds of the depicted environment 550. For brevity, the relevant example features and alternatives discussed with respect to preceding figures may apply to the examples depicted in FIGS. 5A-5C.

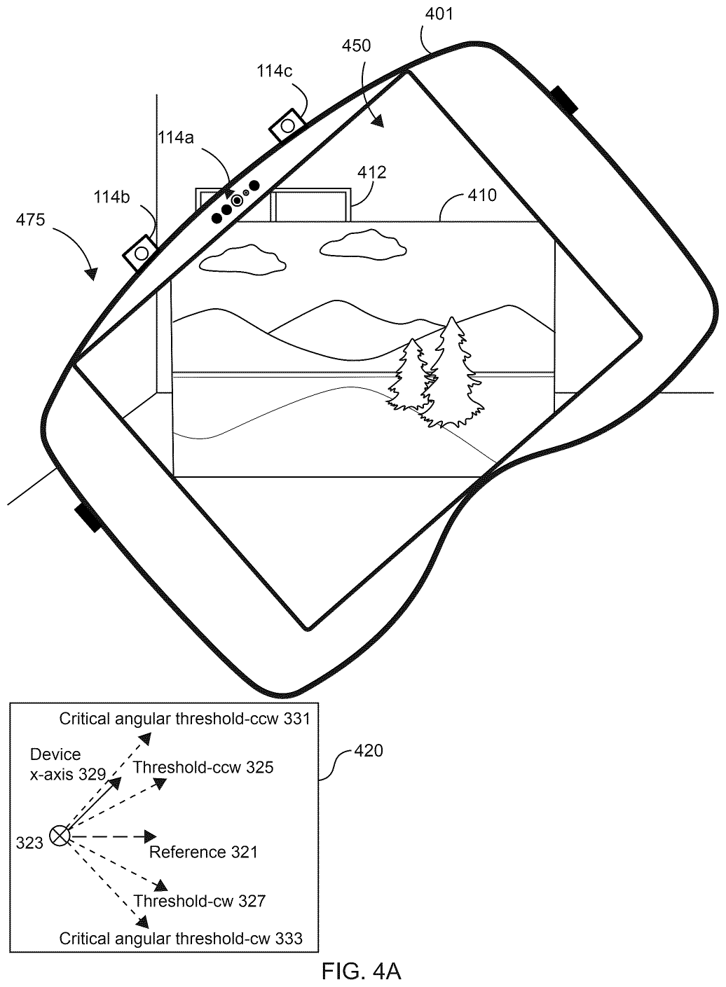

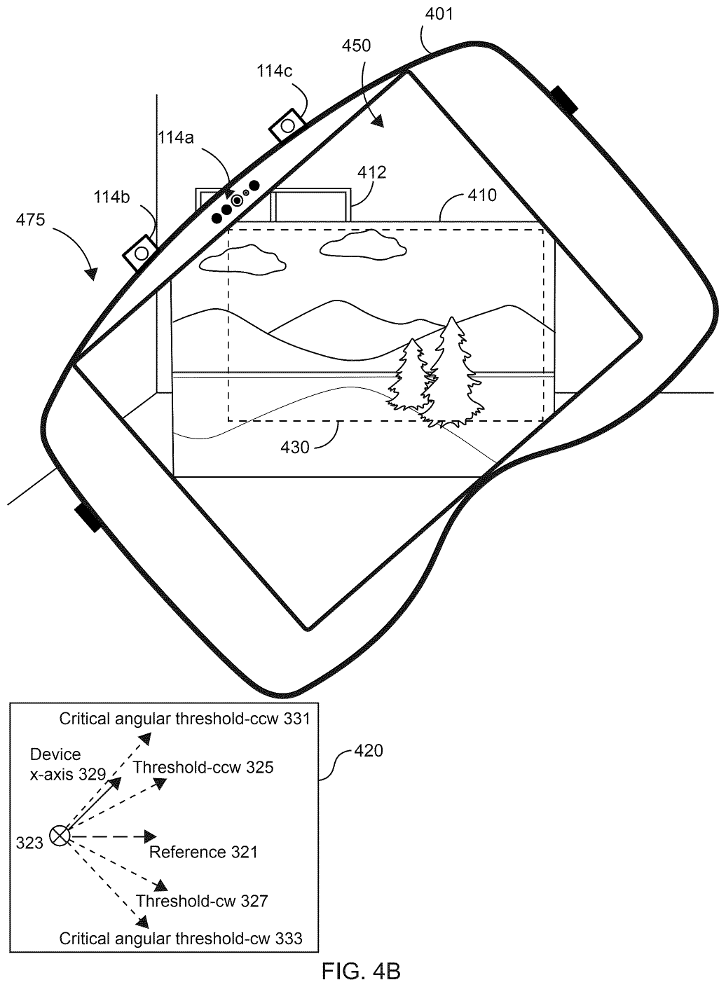

FIG. 4A illustrates an electronic device displaying a representation of a content item 410 that has satisfied one or more criteria for updating the representation of the content item, but does not include a predetermined visual cue in the corner or border regions, and/or the associated content item does not have a playing feature (e.g., a television show or movie) according to some examples of the disclosure. In some examples, the lack of a predetermined visual cue in the corner or border regions and/or the lack of a playing feature means that an anti-clip/crop criterion has not been satisfied, and thus there are no restrictions on clipping or cropping the content item 410. Under these circumstances, an update or adjustment to the representation of the content item 410 from a first visual state to a second visual state can be performed by clipping one or more corner regions of the representation of the content item 410 as shown in FIG. 4A, according to some examples of the disclosure. In some examples, the electronic device 301 can determine the amount of (e.g., or one or more factors associated with) clipping one or more corner regions based on the magnitude of the roll movements (or pitch or yaw movements). For brevity, the example criteria or example features and alternatives discussed with respect to preceding figures may apply to the example depicted in FIGS. 4A-4B.

In some examples, clipping can be limited to the corner regions as defined above. In some examples, the resulting frame of the representation of the content item 310 after clipping the border regions may be a hexagonal, rectangular, or square shaped. Clipping the representation of content item 410 can advantageously preserve the size (e.g., magnification) of the content item, at the expense of sacrificing the clipped portions of the content item. However, because the clipping is performed only when no anti-clip/crop criterion has been satisfied, no visual cues located in the corner or border regions should become hidden.

In some examples, clipping one or more corner regions of the representation of the content item 410 may not be desirable, and maintaining the general shape (e.g., rectangular shape) of the representation of the content item 410 can be preferred. In some examples, an update or adjustment to the representation of the content item 410 from a first visual state to a second visual state can be performed by cropping one or more border regions of the representation of the content item 410 that is outside of the region 430 as shown in FIG. 4B, according to some examples of the disclosures. In some examples, the aspect ratio of the representation of the content item 410 is maintained during and/or after the transition of the representation of the content item 410 (e.g., unless the user provides inputs to change the aspect ratio). In some examples, the new visual state of the representation of the content item 410 may only include the visual content inside of the region 430. In some examples, the electronic device 301 can determine the amount of (e.g., or one or more factors associated with) cropping one or more border regions based on the magnitude of the movements (e.g., or determining the size and placement of the region 430 such that the visual content of the representation of the content outside of the region 430 is cropped).

In some examples, clipping or cropping can occur for larger areas of the representation of the content item such as the border regions as defined above. In some examples, the resulting frame of the representation of the content item 310 after clipping or cropping the border regions may be limited to a square or rectangular shape. In some examples, the corner regions that are clipped or cropped have an equivalent area. Alternatively, in other examples, the clipped or cropped corner regions of the representation of the content item may not have an equivalent area.

For example, in response to movement of the electronic device 401 exceeding an angular movement threshold and a determination that no anti-clip/crop criterion has been satisfied, the electronic device 401 can transition from displaying the representation of the content item 410 from its first visual state that is not clipped or cropped to a second visual state, different from the first visual state, that is clipped or cropped. In some examples, the initial size (area) of the representation of the content item 410 in the first visual state is larger than the size (area) of the representation of the content item in the clipped or cropped second visual state. As shown in the examples of FIGS. 4A-4B, the representation of the content item 410 that is tilt-locked can be clipped or cropped such that a smaller portion of the frame of the updated representation of the content item 410 remains visible in the updated field of view. In the examples of FIGS. 4A-4B, if the movement of the electronic device 401 is reversed such that the one or more angular movement thresholds are no longer satisfied, the electronic device can undo the clipping or cropping in the one or more corner regions of the representation of the content item 410 such that the entirety of the frame of the updated representation of the content item 310 once again becomes visible in the updated field of view and occupies a larger portion of the user's field of view.

It is understood that the examples shown and described herein are merely exemplary and that additional and/or alternative elements may be provided within the three-dimensional environment.

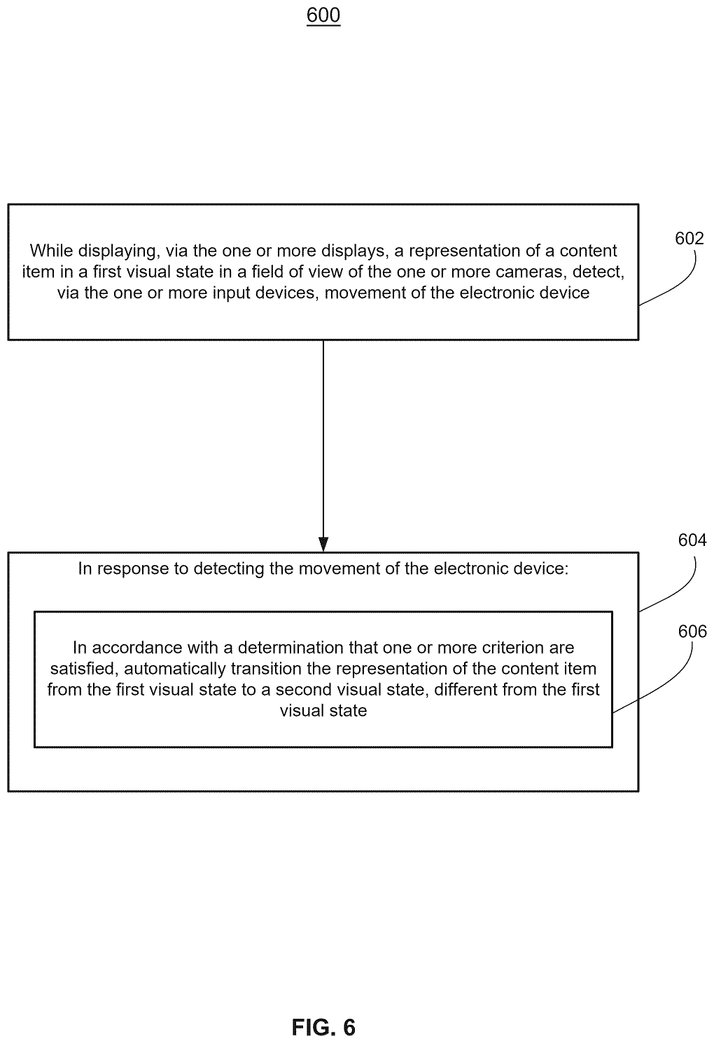

FIG. 6 is a flow diagram illustrating an example process for displaying content and automatically updating content such as a representation of a content item based on detecting movements of the electronic device and in accordance with satisfying one or more criteria according to some examples of the disclosure. In some examples, process 600 begins at an electronic device in communication with one or more displays, one or more input devices, and optionally one or more cameras and/or one or more accelerometer (e.g., to roll, pitch, or yaw movements described herein). In some examples, the electronic device is optionally a head-mounted display similar or corresponding to electronic device 201 of FIG. 2. As shown in FIG. 8, in some examples, at 602, while the electronic device is displaying, via the one or more displays, a representation of a content item in a first visual state in a field of view of the one or more cameras, the electronic device detects, via the one or more input devices, movement of the electronic device. For example, as illustrated in FIG. 3B, while the electronic device 301 is displaying the representation of the content item 310 in a first visual state in the field of view of the one or more cameras, the electronic device 301 detects movement of the electronic device 301.

In some examples, at 604, in response to the electronic device detecting the movement of the electronic device, in accordance with a determination that one or more criteria are satisfied at 606, the electronic device automatically transitions the representation of the content item from the first visual state to a second visual state, different from the first visual state. For example, as described with reference to FIG. 3C, in response to the electronic device 301 detecting movement of the electronic device 301 (e.g., relative to the reference ray 321), in accordance with a determination that one or more criteria (e.g., exceeding movement threshold beyond Threshold-ccw 325), the electronic device 301 automatically transition from its first visual state (e.g., depicted in FIG. 3A) to a second visual state (e.g., depicted in FIG. 3C), different from the first visual state.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising, at an electronic device in communication with one or more cameras, and one or more input devices, while displaying, via the one or more displays, a representation of a content item in a first visual state, detecting, via the one or more input devices, movement of the electronic device; in response to detecting the movement of the electronic device, in accordance with a determination that one or more criteria are satisfied, the one or more criteria including a criterion that is satisfied when the electronic device detects movement of the electronic device that greater than a movement threshold, transitioning the representation of the content item from the first visual state to a second visual state, different from the first visual state; while the representation of the content item is in the second visual state, detecting, via the one or more input devices, ceasing of the movement of the electronic device; and in response to detecting the ceasing of the movement of the electronic device, transitioning the representation of the content item from the second visual state to a third visual state, different from the second visual state. Additionally or alternatively to one or more of the examples described above, in some examples, transitioning the representation of the content item from the first visual state to the second visual state includes updating the representation of the content item from being displayed in a first size to being display in a second size, different from the first size. Additionally or alternatively to one or more of the examples described above, in some examples, the second size is smaller than the first size. Additionally or alternatively to one or more of the examples described above, in some examples, updating the representation of the content item from being displayed in the first size to being display in the second size includes scaling the representation of the content item from the first size of to the second size. Additionally or alternatively to one or more of the examples described above, in some examples, transitioning the representation of the content item from the first visual state to the second visual state includes cropping the representation of the content item. Additionally or alternatively to one or more of the examples described above, in some examples, the movement threshold is an angular movement threshold that is satisfied when the electronic device detects movement of the electronic device that exceeds a predetermined angular rotation. Additionally or alternatively to one or more of the examples described above, in some examples, the movement threshold is an angular movement speed threshold that is satisfied when the electronic device detects a speed or velocity of movement of the electronic device that exceeds a predetermined angular speed or predetermined angular velocity. Additionally or alternatively to one or more of the examples described above, in some examples, the movement threshold is an angular movement acceleration threshold that is satisfied when the electronic device detects an acceleration of movement of the electronic device that exceeds a predetermined angular acceleration. Additionally or alternatively to one or more of the examples described above, in some examples, the one or more criteria further include a criterion that is satisfied when the representation of the content item is a predetermined type of content. Additionally or alternatively to one or more of the examples described above, in some examples, the one or more criteria further include a criterion that is satisfied when the representation of the content item includes a predefined visual cue. Additionally or alternatively to one or more of the examples described above, in some examples, the one or more criteria further include an anti-clip/crop criterion that is satisfied when the predefined visual cue is located in a predefined region of the content item. Additionally or alternatively to one or more of the examples described above, in some examples, in accordance with a determination that the one or more criteria are satisfied, including a determination that the anti-clip/crop criterion is satisfied, the transitioning of the representation of the content item from the first visual state to the second visual state maintains the display of one or more corners and borders of the content item. Additionally or alternatively to one or more of the examples described above, in some examples, the one or more criteria further include a criterion that is satisfied when the representation of the content item is greater than a size threshold. Additionally or alternatively to one or more of the examples described above, in some examples, in accordance with a determination that one or more critical angular movement thresholds of the electronic device have been satisfied, ceasing the transitioning of the representation of the content item from the first visual state to the second visual state. Additionally or alternatively to one or more of the examples described above, in some examples, detecting, via the one or more input devices, ceasing of the movement of the electronic device includes detecting less than a second threshold movement of the electronic device for a predetermined time period. Additionally or alternatively to one or more of the examples described above, in some examples, the method further comprising, while the representation of the content item is in the second visual state, detecting, via the one or more input devices, a threshold time period without user interaction with a displayed user interface, and in response to detecting the threshold time period without user interaction with the displayed user interface, transitioning the representation of the content item from the second visual state to the first visual state. Additionally or alternatively to one or more of the examples described above, in some examples, the method further comprising, in response to detecting the movement of the electronic device, in accordance with a determination that the one or more criteria are not satisfied, forgoing transitioning the representation of the content item from the first visual state to the second visual state.

Some examples of the disclosure are directed to an electronic device, comprising: one or more processors; memory; and one or more programs stored in the memory and configured to be executed by the one or more processors, the one or more programs including instructions for performing any of the above methods. Some examples of the disclosure are directed to an electronic device, comprising: one or more displays, one or more input devices, and one or more processors configured to perform any of the above methods.

Some examples of the disclosure are directed to a non-transitory computer readable storage medium storing one or more programs, the one or more programs comprising instructions, which when executed by one or more processors of an electronic device in communication with one or more displays and one or more input devices, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some examples, the data utilized can include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data can be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more cameras, and one or more input devices:
while displaying, via the one or more displays, a representation of a content item in a first visual state, detecting, via the one or more input devices, movement of the electronic device;
in response to detecting the movement of the electronic device:
in accordance with a determination that one or more criteria are satisfied, the one or more criteria including a criterion that is satisfied when the electronic device detects movement of the electronic device that greater than a movement threshold, transitioning the representation of the content item from the first visual state to a second visual state, different from the first visual state;
while the representation of the content item is in the second visual state, detecting, via the one or more input devices, ceasing of the movement of the electronic device; and
in response to detecting the ceasing of the movement of the electronic device:
transitioning the representation of the content item from the second visual state to a third visual state, different from the second visual state.

2. The method of claim 1, wherein transitioning the representation of the content item from the first visual state to the second visual state includes updating the representation of the content item from being displayed in a first size to being display in a second size, different from the first size.

3. The method of claim 1, wherein transitioning the representation of the content item from the first visual state to the second visual state includes: scaling the representation of the content item from a first size of to a second size or cropping the representation of the content item.

4. The method of claim 1, wherein the movement threshold is an angular movement threshold that is satisfied when the electronic device detects movement of the electronic device that exceeds a predetermined angular rotation, an angular movement speed threshold that is satisfied when the electronic device detects a speed or velocity of movement of the electronic device that exceeds a predetermined angular speed or predetermined angular velocity, or an angular movement acceleration threshold that is satisfied when the electronic device detects an acceleration of movement of the electronic device that exceeds a predetermined angular acceleration.

5. The method of claim 1, wherein the one or more criteria further include one or more of:
a criterion that is satisfied when the representation of the content item includes a predefined visual cue;
an anti-clip/crop criterion that is satisfied when the predefined visual cue is located in a predefined region of the content item; or
a criterion that is satisfied when the representation of the content item is greater than a size threshold.

6. The method of claim 1, further comprising:
in accordance with a determination that one or more critical angular movement thresholds of the electronic device have been satisfied, ceasing the transitioning of the representation of the content item from the first visual state to the second visual state.

7. The method of claim 1, wherein detecting, via the one or more input devices, ceasing of the movement of the electronic device includes detecting less than a second threshold movement of the electronic device for a predetermined time period.

8. The method of claim 1, further comprising:
in response to detecting the movement of the electronic device:
in accordance with a determination that the one or more criteria are not satisfied, forgoing transitioning the representation of the content item from the first visual state to the second visual state.

9. An electronic device comprising:
one or more displays;
one or more input devices, and
one or more processors configured to:
while displaying, via the one or more displays, a representation of a content item in a first visual state, detect, via the one or more input devices, movement of the electronic device;
in response to detecting the movement of the electronic device:
in accordance with a determination that one or more criteria are satisfied, the one or more criteria including a criterion that is satisfied when the electronic device detects movement of the electronic device that greater than a movement threshold, transition the representation of the content item from the first visual state to a second visual state, different from the first visual state;
while the representation of the content item is in the second visual state, detect, via the one or more input devices, ceasing of the movement of the electronic device; and
in response to detecting the ceasing of the movement of the electronic device:
transition the representation of the content item from the second visual state to a third visual state, different from the second visual state.

10. The electronic device of claim 9, wherein transitioning the representation of the content item from the first visual state to the second visual state includes updating the representation of the content item from being displayed in a first size to being display in a second size, different from the first size.

11. The electronic device of claim 9, wherein transitioning the representation of the content item from the first visual state to the second visual state includes: scaling the representation of the content item from a first size of to a second size or cropping the representation of the content item.

12. The electronic device of claim 9, wherein the movement threshold is an angular movement threshold that is satisfied when the electronic device detects movement of the electronic device that exceeds a predetermined angular rotation, an angular movement speed threshold that is satisfied when the electronic device detects a speed or velocity of movement of the electronic device that exceeds a predetermined angular speed or predetermined angular velocity, or an angular movement acceleration threshold that is satisfied when the electronic device detects an acceleration of movement of the electronic device that exceeds a predetermined angular acceleration.

13. The electronic device of claim 9, wherein the one or more criteria further include one or more of:
a criterion that is satisfied when the representation of the content item includes a predefined visual cue;
an anti-clip/crop criterion that is satisfied when the predefined visual cue is located in a predefined region of the content item; or
a criterion that is satisfied when the representation of the content item is greater than a size threshold.

14. The electronic device of claim 9, the one or more processors further configured to:
in accordance with a determination that one or more critical angular movement thresholds of the electronic device have been satisfied, cease the transitioning of the representation of the content item from the first visual state to the second visual state.

15. The electronic device of claim 9, wherein detecting, via the one or more input devices, ceasing of the movement of the electronic device includes detecting less than a second threshold movement of the electronic device for a predetermined time period.

16. The electronic device of claim 9, the one or more processors further configured to:
in response to detecting the movement of the electronic device:
in accordance with a determination that the one or more criteria are not satisfied, forgo transitioning the representation of the content item from the first visual state to the second visual state.

17. A non-transitory computer readable storage medium storing one or more programs, the one or more programs comprising instructions, which when executed by one or more processors of an electronic device in communication with one or more displays and one or more input devices, cause the electronic device to:
while displaying, via the one or more displays, a representation of a content item in a first visual state, detect, via the one or more input devices, movement of the electronic device;
in response to detecting the movement of the electronic device:
in accordance with a determination that one or more criteria are satisfied, the one or more criteria including a criterion that is satisfied when the electronic device detects movement of the electronic device that greater than a movement threshold, transition the representation of the content item from the first visual state to a second visual state, different from the first visual state;
while the representation of the content item is in the second visual state, detect, via the one or more input devices, ceasing of the movement of the electronic device; and
in response to detecting the ceasing of the movement of the electronic device:
transition the representation of the content item from the second visual state to a third visual state, different from the second visual state.

18. The non-transitory computer readable storage medium of claim 17, wherein transitioning the representation of the content item from the first visual state to the second visual state includes updating the representation of the content item from being displayed in a first size to being display in a second size, different from the first size.

19. The non-transitory computer readable storage medium of claim 17, wherein transitioning the representation of the content item from the first visual state to the second visual state includes: scaling the representation of the content item from a first size of to a second size or cropping the representation of the content item.

20. The non-transitory computer readable storage medium of claim 17, wherein the movement threshold is an angular movement threshold that is satisfied when the electronic device detects movement of the electronic device that exceeds a predetermined angular rotation, an angular movement speed threshold that is satisfied when the electronic device detects a speed or velocity of movement of the electronic device that exceeds a predetermined angular speed or predetermined angular velocity, or an angular movement acceleration threshold that is satisfied when the electronic device detects an acceleration of movement of the electronic device that exceeds a predetermined angular acceleration.

21. The non-transitory computer readable storage medium of claim 17, wherein the one or more criteria further include one or more of:
a criterion that is satisfied when the representation of the content item includes a predefined visual cue;
an anti-clip/crop criterion that is satisfied when the predefined visual cue is located in a predefined region of the content item; or
a criterion that is satisfied when the representation of the content item is greater than a size threshold.

22. The non-transitory computer readable storage medium of claim 17, further storing instructions which, when executed by the one or more processors, further cause the electronic device to:
in accordance with a determination that one or more critical angular movement thresholds of the electronic device have been satisfied, cease the transitioning of the representation of the content item from the first visual state to the second visual state.

23. The non-transitory computer readable storage medium of claim 17, wherein detecting, via the one or more input devices, ceasing of the movement of the electronic device includes detecting less than a second threshold movement of the electronic device for a predetermined time period.

24. The non-transitory computer readable storage medium of claim 17, further storing instructions which, when executed by the one or more processors, further cause the electronic device to:
in response to detecting the movement of the electronic device:
in accordance with a determination that the one or more criteria are not satisfied, forgo transitioning the representation of the content item from the first visual state to the second visual state.
